(19) United States
(12) Patent Application Publication
(10) Pub. No.: US 2026/0220381 A1
(43) Pub. Date: Jul. 30, 2026

(54) Persistent Cognitive Machine with Bidirectional Geometric Interface Between Lorentzian and Epistemic Latent Manifolds

(71) Applicant: AtomBeam Technologies Inc., Moraga, CA (US)

(72) Inventor: Brian Galvin, Silverdale, WA (US)

(21) Appl. No.: 19/630,363

(22) Filed: Mar. 26, 2026

Related U.S. Application Data
(63) Continuation-in-part of application No. 19/550,709, filed on Feb. 26, 2026.
Application No. 19/550,709 is a continuation-in-part of application No. 19/548,024, filed on Feb. 24, 2026.
Application No. 19/548,024 is a continuation-in-part of application No. 19/546,407, filed on Feb. 22, 2026.
Application No. 19/546,407 is a continuation-in-part of application No. 19/534,677, filed on Feb. 9, 2026, now Pat. No. 12,651,010.
(63) Continuation-in-part of application No. 19/412,830, filed on Dec. 8, 2025.
Application No. 19/412,830 is a continuation-in-part of application No. 19/401,343, filed on Nov. 25, 2025.
Application No. 19/401,343 is a continuation-in-part of application No. 19/390,468, filed on Nov. 14, 2025.
Application No. 19/390,468 is a continuation-in-part of application No. 19/380,869, filed on Nov. 5, 2025.
Application No. 19/380,869 is a continuation-in-part of application No. 19/369,319, filed on Oct. 26, 2025.
Application No. 19/369,319 is a continuation-in-part of application No. 19/363,675, filed on Oct. 21, 2025.
Application No. 19/363,675 is a continuation-in-part of application No. 19/351,286, filed on Oct. 6, 2025.
Application No. 19/351,286 is a continuation-in-part of application No. 19/321,173, filed on Sep. 6, 2025, now Pat. No. 12,602,549.
Application No. 19/321,173 is a continuation-in-part of application No. 19/284,115, filed on Jul. 29, 2025.
Application No. 19/284,115 is a continuation of application No. 19/051,193, filed on Feb. 12, 2025, now Pat. No. 12,387,050.
Application No. 19/369,319 is a continuation-in-part of application No. 19/328,179, filed on Sep. 14, 2025.
Application No. 19/328,179 is a continuation-in-part of application No. 19/326,730, filed on Sep. 12, 2025, now Pat. No. 12,608,555.
Application No. 19/326,730 is a continuation-in-part of application No. 19/321,173, filed on Sep. 6, 2025, now Pat. No. 12,602,549.
Application No. 19/321,173 is a continuation-in-part of application No. 19/245,366, filed on Jun. 22, 2025, now Pat. No. 12,418,680.
Application No. 19/245,366 is a continuation-in-part of application No. 19/204,525, filed on May 10, 2025.
Application No. 19/204,525 is a continuation-in-part of application No. 19/192,215, filed on Apr. 28, 2025.
Application No. 19/192,215 is a continuation-in-part of application No. 18/972,797, filed on Dec. 6, 2024, now Pat. No. 12,294,392.
Application No. 18/972,797 is a continuation-in-part of application No. 18/648,340, filed on Apr. 27, 2024, now Pat. No. 12,166,507.
Application No. 18/648,340 is a continuation-in-part of application No. 18/427,716, filed on Jan. 30, 2024, now Pat. No. 12,093,972.
Application No. 18/427,716 is a continuation-in-part of application No. 18/410,980, filed on Jan. 11, 2024, now Pat. No. 12,068,761.
Application No. 18/410,980 is a continuation-in-part of application No. 18/537,728, filed on Dec. 12, 2023, now Pat. No. 12,058,333.
Application No. 18/537,728 is a continuation-in-part of application No. 19/329,369, filed on Sep. 15, 2025.
Application No. 19/329,369 is a continuation-in-part of application No. 19/328,199, filed on Sep. 14, 2025, now Pat. No. 12,645,884.
Application No. 19/328,199 is a continuation-in-part of application No. 19/328,179, filed on Sep. 14, 2025.
Application No. 19/328,179 is a continuation-in-part of application No. 19/328,103, filed on Sep. 13, 2025, now Pat. No. 12,639,521.
Application No. 19/328,103 is a continuation-in-part of application No. 19/326,730, filed on Sep. 12, 2025, now Pat. No. 12,608,555.
Application No. 19/390,468 is a continuation-in-part of application No. 19/203,069, filed on Jun. 3, 2025, now Pat. No. 12,481,688.
Application No. 19/203,069 is a continuation-in-part of application No. 19/205,960, filed on May 12, 2025.
Application No. 19/205,960 is a continuation-in-part of application No. 19/060,794, filed on Feb. 24, 2025.
Application No. 19/060,794 is a continuation-in-part of application No. 19/044,546, filed on Feb. 3, 2025.
Application No. 19/044,546 is a continuation-in-part of application No. 19/026,276, filed on Jan. 16, 2025.
Application No. 19/026,276 is a continuation-in-part of application No. 18/928,022, filed on Oct. 26, 2024.
Application No. 18/928,022 is a continuation-in-part of application No. 18/919,417, filed on Oct. 17, 2024, now Pat. No. 12,602,586.
Application No. 18/919,417 is a continuation-in-part of application No. 18/918,077, filed on Oct. 17, 2024.
Application No. 18/918,077 is a continuation-in-part of application No. 18/737,906, filed on Jun. 7, 2024.
Application No. 18/737,906 is a continuation-in-part of application No. 18/736,498, filed on Jun. 6, 2024.
(60) Provisional application No. 63/651,359, filed on May 23, 2024.
(60) Provisional application No. 63/847,082, filed on Jul. 19, 2025.
(60) Provisional application No. 63/847,091, filed on Jul. 19, 2025.
(60) Provisional application No. 63/847,096, filed on Jul. 19, 2025.
(60) Provisional application No. 63/847,101, filed on Jul. 19, 2025.
(60) Provisional application No. 63/847,889, filed on Jul. 21, 2025.
(60) Provisional application No. 63/887,491, filed on Sep. 24, 2025.
(60) Provisional application No. 63/965,251, filed on Jan. 21, 2026.
(60) Provisional application No. 63/965,273, filed on Jan. 21, 2026.
(60) Provisional application No. 63/965,321, filed on Jan. 21, 2026.
(60) Provisional application No. 63/966,904, filed on Jan. 23, 2026.
(60) Provisional application No. 63/966,944, filed on Jan. 23, 2026.
(60) Provisional application No. 63/966,955, filed on Jan. 23, 2026.
(60) Provisional application No. 63/967,705, filed on Jan. 25, 2026.
(60) Provisional application No. 63/967,707, filed on Jan. 25, 2026.
(60) Provisional application No. 63/967,710, filed on Jan. 25, 2026.
(60) Provisional application No. 63/967,713, filed on Jan. 25, 2026.
(60) Provisional application No. 63/967,715, filed on Jan. 25, 2026.
(60) Provisional application No. 63/967,718, filed on Jan. 25, 2026.
(60) Provisional application No. 63/967,721, filed on Jan. 25, 2026.
(60) Provisional application No. 63/967,726, filed on Jan. 25, 2026.
(60) Provisional application No. 63/968,152, filed on Jan. 26, 2026.
(60) Provisional application No. 63/968,157, filed on Jan. 26, 2026.
(60) Provisional application No. 63/975,311, filed on Feb. 3, 2026.
(60) Provisional application No. 63/975,314, filed on Feb. 3, 2026.
(60) Provisional application No. 63/976,098, filed on Feb. 4, 2026.
(60) Provisional application No. 63/976,101, filed on Feb. 4, 2026.
(60) Provisional application No. 63/976,103, filed on Feb. 4, 2026.
(60) Provisional application No. 63/976,109, filed on Feb. 4, 2026.
(60) Provisional application No. 63/976,115, filed on Feb. 4, 2026.
(60) Provisional application No. 63/978,340, filed on Feb. 9, 2026.
(60) Provisional application No. 63/978,983, filed on Feb. 9, 2026.
(60) Provisional application No. 63/978,991, filed on Feb. 9, 2026.
(60) Provisional application No. 63/978,997, filed on Feb. 9, 2026.
(60) Provisional application No. 63/985,880, filed on Feb. 18, 2026.

(51) Int. Cl. G06F 40/30; G06F 16/332; G06F 16/3329

(52) U.S. Cl. CPC G06F 40/30; G06F 16/3325; G06F 16/3329

(57) ABSTRACT

A system and method for a persistent cognitive machine that maintains two geometrically distinct latent manifolds in hardware memory. The first manifold encodes spatiotemporal or perceptually derived states under a geometric metric that governs causal ordering and predictive trajectory computation. The second manifold encodes cognitive states under epistemic conditioning that defines capacity constraints, admissibility boundaries, and forbidden regions for reasoning trajectories. A bidirectional geometric interface operator serves as the exclusive pathway for state exchange between the two manifolds. For transfers from the first manifold to the second, the operator performs structural reconciliation and evaluates capacity and admissibility constraints before permitting incorporation. For transfers from the second manifold to the first, the operator verifies epistemic eligibility and physical plausibility before permitting incorporation. States that fail either evaluation are not transferred. All cross-manifold transfers are recorded through journaling that maintains reversible mappings between source and target states within bounded error tolerances.

### CROSS-REFERENCE TO RELATED APPLICATIONS

Priority is claimed in the application data sheet to the following patents or patent applications, each of which is expressly incorporated herein by reference in its entirety:
Ser. No. 19/550,709
Ser. No. 19/548,024
Ser. No. 19/546,407
Ser. No. 19/534,677
63/985,880
63/978,340
63/978,983
63/978,991
63/978,997
63/976,098
63/976,101
63/976,103
63/976,109
63/976,115
63/975,311
63/975,314
63/968,152
63/968,157
63/967,705
63/967,707
63/967,710
63/967,713
63/967,715
63/967,718
63/967,721
63/967,726
63/966,904
63/966,944
63/966,955
63/965,251
63/965,273
63/965,321
Ser. No. 19/412,830
Ser. No. 19/401,343
Ser. No. 19/390,468
Ser. No. 19/380,869
Ser. No. 19/369,319
Ser. No. 19/363,675
Ser. No. 19/351,286
Ser. No. 19/321,173
Ser. No. 19/284,115
Ser. No. 19/051,193
63/847,082
63/847,091
63/847,096
63/847,101
Ser. No. 19/328,179
Ser. No. 19/326,730
63/847,889
Ser. No. 19/245,366
Ser. No. 19/204,525
Ser. No. 19/192,215
Ser. No. 18/972,797
Ser. No. 18/648,340
Ser. No. 18/427,716
Ser. No. 18/410,980
Ser. No. 18/537,728
63/887,491
Ser. No. 19/329,369
Ser. No. 19/328,199
Ser. No. 19/328,103
Ser. No. 19/203,069
Ser. No. 19/205,960
Ser. No. 19/060,794
Ser. No. 19/044,546
Ser. No. 19/026,276
Ser. No. 18/928,022
Ser. No. 18/919,417
Ser. No. 18/918,077
Ser. No. 18/737,906
Ser. No. 18/736,498
63/651,359

### BACKGROUND OF THE INVENTION

### Field of the Art

The present invention relates to the field of machine-implemented cognitive computing architectures, and more specifically to persistent cognitive systems comprising geometrically distinct latent manifolds coupled through a bidirectional geometric interface operator that enforces capacity-and admissibility-constrained state exchange between perceptual and epistemic domains.

### Discussion of the State of the Art

Modern artificial intelligence systems increasingly integrate perceptual processing, predictive modeling, and cognitive reasoning within unified computational frameworks. Systems incorporating deep neural networks, multimodal embeddings, and large-scale latent representations are capable of ingesting heterogeneous sensor data, generating predictive simulations, and performing high-level reasoning tasks. In many such systems, perceptual representations and reasoning representations are implemented within shared latent vector spaces or are coupled through learned attention mechanisms or feature concatenation architectures.

Predictive modeling systems operating on structured sensor data have introduced latent spaces endowed with geometric structure, including manifolds supporting trajectory forecasting and uncertainty propagation. Similarly, cognitive architectures have been proposed in which reasoning is represented as traversal through latent manifolds subject to admissibility constraints, memory consolidation mechanisms, or coherence diagnostics. However, these developments have largely occurred in parallel domains.

Conventional multimodal systems typically integrate perceptual and cognitive representations through direct feature concatenation, cross-attention layers, shared embedding projections, or loosely constrained learned mappings between modalities. Such integration mechanisms generally do not enforce formal geometric compatibility conditions between distinct latent spaces, nor do they impose capacity constraints or admissibility gating at the boundary between perceptual and reasoning substrates. As a result, perceptual instability may propagate into cognitive reasoning without structured mediation, and internally inconsistent cognitive hypotheses may be exported into predictive simulation environments without physical plausibility validation.

Furthermore, existing systems lack a formally defined architectural boundary between perceptual manifolds structured by spatiotemporal or causal geometry and cognitive manifolds structured by epistemic conditioning. In many implementations, perceptual states and cognitive states coexist within a unified embedding space, blurring distinctions between physical plausibility constraints and epistemic admissibility constraints. Without a computationally enforced interface boundary, cross-modal contamination may occur, enabling uncontrolled feedback loops between predictive simulation and reasoning processes.

Although prior persistent cognitive architectures have introduced admissibility gating within a reasoning manifold, and predictive modeling architectures have introduced causal or Lorentzian structure within perceptual manifolds, the art does not disclose a machine-implemented system comprising two geometrically distinct latent manifolds maintained concurrently and coupled through a formally defined bidirectional geometric interface operator that enforces capacity constraints, admissibility constraints, and structural reconciliation prior to cross-manifold incorporation.

Accordingly, the state of the art lacks a persistent cognitive machine in which perceptual spatiotemporal dynamics and epistemically conditioned reasoning are maintained as separate geometric substrates with a computationally enforced boundary regulating structured state exchange between them.

What is needed is a computer-implemented persistent cognitive system comprising a first latent manifold structured under a geometric metric governing causal ordering and predictive trajectory computation, a second latent manifold structured under epistemic conditioning defining capacity and admissibility constraints for reasoning trajectories, and a formally defined bidirectional geometric interface operator that mediates admissible, capacity-constrained, structure-preserving state exchange between the two manifolds while maintaining reversible cross-manifold journaling and preventing uncontrolled cross-modal state propagation.

### SUMMARY OF THE INVENTION

Accordingly, the inventor has conceived and reduced to practice a persistent cognitive machine comprising two geometrically distinct latent manifolds maintained concurrently in hardware memory and coupled through a formally defined bidirectional geometric interface operator that mediates admissible, capacity-constrained, structure-preserving state exchange between the manifolds. A first latent manifold encodes spatiotemporal or perceptually derived states under a geometric metric governing causal ordering and predictive trajectory computation. A second latent manifold encodes cognitive states under epistemic conditioning information defining capacity constraints, admissibility boundaries, and restricted reasoning regions. The bidirectional geometric interface operator defines a computationally enforced boundary between the manifolds and conditionally incorporates states across that boundary only when cross-manifold capacity, admissibility, epistemic eligibility, and physical plausibility constraints are satisfied. Cross-manifold transfers are recorded through reversible journaling mechanisms that preserve reconstructability within bounded error tolerances, thereby enabling auditable coupling between perception, reasoning, and simulation while preventing uncontrolled cross-modal state propagation.

In an embodiment, a computer system maintains in hardware memory a first latent manifold structured to encode spatiotemporal or perceptually derived states according to a geometric metric governing causal ordering and predictive trajectory computation, and maintains in hardware memory a second latent manifold structured to encode cognitive states according to epistemic conditioning information defining at least one of capacity constraints, admissibility boundaries, or forbidden regions for reasoning trajectories, wherein the first latent manifold and the second latent manifold are geometrically distinct and maintained as separate representational substrates. The computer system executes a bidirectional geometric interface operator that mediates structured state exchange between the first latent manifold and the second latent manifold, such that for inbound transfer from the first latent manifold to the second latent manifold the interface operator evaluates capacity and admissibility constraints derived from geometric properties of the second latent manifold and incorporates a transferred state into the second latent manifold as an active cognitive state only when the capacity and admissibility constraints are satisfied, and for outbound transfer from the second latent manifold to the first latent manifold the interface operator evaluates epistemic eligibility constraints and physical plausibility constraints derived from geometric properties of the first latent manifold and incorporates a transferred state into the first latent manifold only when both constraints are satisfied. The system maintains reversible mappings between states transferred across the boundary through cross-manifold journaling with bounded error tolerances.

In an aspect of an embodiment, the first latent manifold is endowed with a pseudo-Riemannian metric of Lorentzian signature encoding causal ordering relationships among encoded states and supporting geodesic trajectory computation and uncertainty representation through causal cone structures, and the second latent manifold is endowed with a semantic metric, an almost-complex structure, a symplectic form reconstructed from the semantic metric and the almost-complex structure under a compatibility relation, and an epistemic connection assigning transition-specific phase values to transitions between cognitive states such that two regions of the second latent manifold that are identical under the semantic metric may nevertheless exhibit different epistemic curvature values reflecting different levels of evidential support.

In an aspect of an embodiment, evaluating projected structural density for inbound transfer comprises computing a local capacity measure derived from a symplectic structure of the second latent manifold over a neighborhood of a provisional insertion location and comparing a projected post-insertion density to a stored capacity threshold, and evaluating physical plausibility constraints for outbound transfer comprises computing a deformation energy induced by embedding a cognitive state into the first latent manifold and verifying that the embedded state does not violate compression-pressure constraints of the first latent manifold.

In an aspect of an embodiment, evaluating admissibility constraints for inbound transfer comprises computing a structural compatibility residual by comparing a geometric structure interpolated at a provisional insertion location against geometric structures at neighboring locations in the second latent manifold, performing phase screening over short closed paths through the provisional insertion location to detect local epistemic inconsistency, and determining whether the provisional insertion location conflicts with an admissibility boundary or consolidated reservoir boundary of the second latent manifold, and evaluating epistemic eligibility constraints for outbound transfer comprises verifying that a candidate cognitive state is not marked epistemically inadmissible and does not belong to a suppressed reasoning trajectory class.

In an aspect of an embodiment, the bidirectional geometric interface operator translates uncertainty representations between the first latent manifold and the second latent manifold by transforming uncertainty structures of the first latent manifold into epistemic confidence measures compatible with the epistemic conditioning of the second latent manifold for inbound transfers and transforming epistemic uncertainty measures of the second latent manifold into visual uncertainty encodings including opacity gradients, branching trajectory overlays, or probabilistic perturbation envelopes for outbound transfers, wherein the translation preserves monotonic relationships between uncertainty magnitude in the source and target manifolds.

In an aspect of an embodiment, cross-manifold journaling maintains a cryptographically verified, tamper-evident record of each transfer event by recording source manifold coordinates, target manifold coordinates, transformation parameters, and capacity and admissibility decision codes, and linking successive records through cryptographic hashes such that any state in either manifold that originated through cross-manifold transfer is traceable through stored transformation parameters to its source manifold state within bounded reconstruction error.

In an aspect of an embodiment, the bidirectional geometric interface operator enforces logical isolation between the first latent manifold and the second latent manifold by preventing states from the first latent manifold from influencing high-commitment cognitive states in the second latent manifold without satisfying admissibility constraints and by preventing cognitive states from the second latent manifold from reaching actuator outputs or simulation outputs without first being incorporated into the first latent manifold and satisfying physical plausibility constraints of the first latent manifold.

In an aspect of an embodiment, the system further executes an adaptive recalibration process that periodically adjusts capacity thresholds, projection norms, and structural compatibility mappings of the bidirectional geometric interface operator based on current geometric properties of the first latent manifold and the second latent manifold and on historical transfer performance records retrieved from the cross-manifold journaling such that interface constraints remain calibrated as the first latent manifold and the second latent manifold grow and evolve over time.

In an aspect of an embodiment, the first latent manifold and the second latent manifold are maintained on separate computational nodes and the bidirectional geometric interface operator is implemented as a network-mediated geometric projection protocol that transfers structured latent state representations and associated metadata between nodes without transferring raw perceptual data or internal reasoning trajectories, and interface capacity mediation is applied prior to transmission to enforce bounded cross-node transfer volume and structural consistency.

Method embodiments corresponding to the foregoing computer system embodiments perform the same functional operations in method-executed form and apply equally to maintaining the dual latent manifolds, executing the bidirectional geometric interface operator, performing capacity and admissibility mediation, translating uncertainty representations, maintaining reversible cross-manifold journaling, enforcing logical isolation, performing adaptive recalibration, and implementing distributed projection protocols; for brevity, the method versions are not restated separately.

### BRIEF DESCRIPTION OF THE DRAWING FIGURES

FIG. 1 is a block diagram illustrating an overall system architecture of a persistent cognitive machine comprising dual geometrically distinct latent manifolds coupled through a bidirectional geometric interface operator and associated subsystems.

FIG. 2 is a block diagram illustrating internal geometric structures of a first latent manifold and a second latent manifold, emphasizing their distinct metric formalisms and structural separation across an interface boundary.

FIG. 3 is a block diagram illustrating internal architecture of a bidirectional geometric interface operator, including inbound and outbound projection components, capacity mediation, admissibility evaluation, uncertainty translation, journaling, and recalibration subsystems.

FIG. 4 is a block diagram illustrating a distributed deployment configuration in which the dual latent manifolds are maintained on separate computational nodes and coupled through a network-mediated geometric projection protocol.

FIG. 5 is a flow diagram illustrating an inbound projection process in which a candidate state from a first latent manifold is structurally reconciled, evaluated for capacity and admissibility, and conditionally incorporated into a second latent manifold.

FIG. 6 is a flow diagram illustrating an outbound projection process in which a cognitive state from a second latent manifold is evaluated for epistemic eligibility and physical plausibility and conditionally incorporated into a first latent manifold for predictive simulation.

FIG. 7 is a flow diagram illustrating a reasoning traversal and output process within a second latent manifold, including phase accumulation, regime classification, consolidation, suppression, and admissibility-conditioned output generation.

FIG. 8 is a flow diagram illustrating a bidirectional anomaly escalation loop in which anomalous states detected in a first latent manifold are escalated to a second latent manifold for reasoning and returned for predictive simulation under interface mediation.

FIG. 9 is a flow diagram illustrating end-to-end operational data flow across ingestion, predictive rollout, bidirectional interface transfer, reasoning traversal, simulation, journaling, and adaptive feedback within a dual-manifold persistent cognitive machine.

FIG. 10 is a flow diagram illustrating an adaptive interface recalibration process in which historical transfer records and current manifold properties are evaluated to update capacity thresholds, projection norms, and structural compatibility mappings for subsequent cross-manifold transfers.

FIG. 11 illustrates an exemplary computing environment on which an embodiment described herein may be implemented.

### DETAILED DESCRIPTION OF THE INVENTION

The inventor has conceived and reduced to practice a system and method for operating a persistent cognitive machine comprising dual geometrically distinct latent manifolds coupled through a bidirectional geometric interface that enforces capacity-constrained, admissibility-gated, structure-preserving state exchange between perceptual and epistemic domains. In an embodiment, a first latent manifold encodes spatiotemporal or perceptually derived states under a geometric metric governing causal ordering and predictive trajectory computation, and a second latent manifold encodes cognitive states under epistemic conditioning information that defines capacity constraints, admissibility boundaries, and restricted reasoning regions. A bidirectional geometric interface operator mediates all state transfer between the manifolds, performs structural reconciliation across geometric domains, evaluates cross-manifold capacity and admissibility thresholds, conditionally incorporates projected states into a target manifold, and maintains reversible journaling sufficient to reconstruct transfer events within bounded error tolerances. By maintaining perceptual and cognitive representations as distinct geometric substrates coupled only through an enforced interface boundary, the system prevents uncontrolled cross-modal propagation and preserves structural integrity of each manifold.

In an embodiment, a first latent manifold is structured to represent perceptually derived or telemetry-derived the system states in a geometric space endowed with a metric governing causal ordering relationships. In a non-limiting example, such metric may be pseudo-Riemannian and may possess Lorentzian signature, such as (−, +, +, +, . . . ), where negative component encodes temporal ordering and positive components encode spatial or feature dimensions. In an embodiment, manifold may be represented discretely as a graph or simplicial complex comprising vertices corresponding to encoded states, edges corresponding to metric relationships, and stored connection coefficients Γ^{k}ᵢⱼ governing geodesic transitions. In an embodiment, predictive evolution of a state xᵥ at time t may be computed by applying a transition operator Tᵥ mapping Mᵥ(t) to Mᵥ(t+Δt). For example, geodesic evolution may be expressed in non-limiting form as d²x^{k}/dτ²+Γ^{k}ᵢⱼ (dxᵢ/dτ)(dxⱼ/dτ)=0, subject to compression-pressure constraints that penalize trajectories entering physically implausible regions. Uncertainty associated with a perceptual state may be represented, for example, through covariance matrices Σ or through causal cone structures whose angular width expands proportionally to prediction horizon and stored variance parameters.

In an embodiment, a second latent manifold is structured to represent cognitive states and reasoning trajectories under epistemic conditioning. In a non-limiting example, manifold may comprise a semantic metric g_c defined over edges connecting cognitive states, an almost-complex structure J defined at each vertex satisfying J²=−Id, a symplectic form ω reconstructed from g_c and J under a compatibility relation such as ω(X, Y)=g_c(JX, Y), and an epistemic connection A assigning transition-specific phase values to directed edges. In an embodiment, discrete epistemic curvature F may be computed as F=dA, and in a discrete representation may be computed as a sum of edge phase values around a closed face, for example F_f=θᵢⱼ+θⱼₖ+θₖᵢ modulo 2π. Accumulated epistemic phase Φ(γ) along a reasoning trajectory γ may be expressed, for example, as Φ(γ)=Σθ along edges of γ. Regions of manifold that are identical under semantic metric may exhibit different curvature values F reflecting different levels of evidential support. In an embodiment, local capacity may be derived from symplectic form, and a capacity density ρ_ω may be computed as a ratio of local state count to computed symplectic capacity, such as ρ_ω=N_local/c_ω. Admission of new cognitive states may be denied when projected post-insertion density exceeds stored threshold.

In an embodiment, reasoning within cognitive manifold proceeds as traversal along edges of manifold while monitoring accumulated epistemic phase and structural compatibility. Closed reasoning paths may be classified, for example, into coherent regime when |Φ(γ)|≤Φ*, drift regime when Φ*<|Φ(γ)|<π, and inversion regime when |Φ(γ)|≥π. Drift regime trajectories may require corroboration through independent paths not deformable within reservoir-stratified state space. Regions satisfying phase flatness, such as |F|≤ε_R over neighborhood, and exhibiting boundary energy above barrier threshold may be consolidated as irreversible reservoirs. Boundary energy may be computed, for example, as E_∂U=∫∂U (α_F |F|²+α_K|K_∂|²+α_ω|dω_ν|²) dμ, where terms represent curvature magnitude, extrinsic boundary curvature, and symplectic variation. Geometric structures may evolve on separated timescales, such as fast projection perturbations, intermediate compression flow minimizing geometric energy including Nijenhuis tensor magnitude ∥N_J∥², and slow connection relaxation flow updating θᵢⱼ←θᵢⱼ−η_R∂E_A/∂θᵢⱼ where E_A=ΣF_f².

In an embodiment, bidirectional geometric interface operator defines computational boundary between manifolds. Interface operator receives a structured state from source manifold, computes a provisional embedding in target manifold through structural reconciliation, evaluates projected structural density, deformation energy, and uncertainty amplification relative to target manifold capacity thresholds, evaluates admissibility constraints derived from target manifold geometry, and conditionally incorporates projected state only when constraints are satisfied. For inbound projection from perceptual manifold to cognitive manifold, interface operator may transform Lorentzian covariance structures or uncertainty cones into epistemic confidence measures, normalize scale differences between geometric metrics, and project state into local tangent approximation of cognitive manifold. Projected density \hat{ρ}_ω may be computed relative to symplectic capacity of neighborhood, and insertion may be vetoed or flagged when \hat{ρ}_ω exceeds stored threshold. Structural compatibility residual may be computed, for example, as r_J(p₀)=max_ [symbol] ∥(Π_{p₀→ [symbol] }) J_{p₀} (Π_{p₀→ [symbol] })⁻¹−J_ [symbol] ∥, and micro-holonomy screening may verify |Φ(γ_short)|≤Φ* for bounded-length loops.

For outbound projection from cognitive manifold to perceptual manifold, interface operator may verify that candidate cognitive state is not marked epistemically inadmissible and does not belong to suppressed trajectory class, and may compute deformation energy induced by embedding into perceptual manifold. Projection may employ exponential or logarithmic maps relative to local geodesic structure, for example \tilde{x}ᵥ=exp_{xᵥ}(Δx) or Δx=log_{xᵥ}(\tilde{x}ᵥ). Compression-pressure constraints of perceptual manifold may be evaluated to ensure embedded state lies within physically plausible region. States failing capacity or admissibility checks are not incorporated.

In an embodiment, interface operator maintains reversible mappings between source and projected states through journaling mechanism stored in non-volatile memory. Journaling record may include source manifold identifier, source coordinates, target manifold identifier, projected coordinates, transformation parameters, capacity and admissibility decision codes, timestamp, and cryptographic hash linking successive entries. Hash chain may be expressed, for example, as H_n=hash(H_{n−1}∥record_n). Stored transformation parameters may permit inverse or approximate inverse mapping within bounded error tolerance, such as ∥x_source−R\hat{ }{−1} (x_projected)∥≤ε.

In an embodiment, interface operator enforces logical isolation between manifolds by preventing direct state incorporation except through interface pathway. Perceptual states may not influence high-commitment cognitive states without satisfying admissibility evaluation, and cognitive states may not generate simulation outputs or actuator commands without first being incorporated into perceptual manifold and satisfying physical plausibility constraints.

In an embodiment, adaptive recalibration process periodically adjusts capacity thresholds, projection norms, and structural compatibility mappings based on current geometric properties of both manifolds and historical transfer performance retrieved from journaling records. Such recalibration may occur during consolidation cycles and may refine projection parameters to preserve stability as manifold sizes increase.

In an embodiment, perceptual manifold and cognitive manifold may be maintained on separate computational nodes connected through network interface, and interface operator may be implemented as network-mediated geometric projection protocol transferring structured latent state representations and associated metadata without transferring raw sensor data or internal reasoning trajectories. Interface capacity mediation may be applied prior to transmission to enforce bounded cross-node transfer volume and maintain structural consistency.

In operation, perceptual ingestion writes encoded sensor states into perceptual manifold, predictive rollout computes forward geodesic trajectories and uncertainty representations, anomalous or selected states are projected into cognitive manifold through inbound interface pathway subject to capacity and admissibility gating, cognitive reasoning evaluates evidential consistency and may produce hypotheses, and selected cognitive states are projected back into perceptual manifold for predictive simulation through outbound interface pathway. All cross-manifold transfers are recorded in journaling subsystem, preserving reversible traceability between perception, reasoning, and simulation.

Through dual-manifold architecture coupled by formally defined bidirectional geometric interface operator enforcing structural reconciliation, capacity mediation, admissibility gating, and reversible journaling, persistent cognitive machine maintains separation between spatiotemporal predictive dynamics and epistemically conditioned reasoning while enabling controlled, auditable interaction between them.

In an embodiment, the computational operations of the bidirectional geometric interface operator and associated manifold structures may be accelerated using parallel processing resources including graphics processing units or other hardware accelerators. Tensor projections from the first latent manifold to the second latent manifold may be executed as batched matrix operations distributed across parallel processing cores. Capacity density calculations may be parallelized across local neighborhoods of the target manifold, and admissibility checks may operate concurrently on sets of candidate insertion states. Geodesic solvers operating within the first latent manifold may likewise be implemented using GPU-accelerated tensor operations. Because the interface operator acts on bounded local neighborhoods or specific state vectors, the computational complexity per transfer event remains bounded independently of total manifold size under sublinear growth assumptions, preserving real-time performance as the system accumulates experience.

In an embodiment, the system may operate in a human-supervised mode in which predictive visual outputs derived from cognitive hypotheses projected into the first latent manifold are presented to a human operator. The operator may confirm, reject, or annotate the simulated outcomes. Such feedback may be re-incorporated into the second latent manifold as additional cognitive insertions, each of which passes through the standard inbound interface pathway and is subject to the same capacity and admissibility evaluation applied to any other inbound transfer. This configuration preserves the structural integrity of both manifolds while permitting human judgment to participate in the reasoning and simulation cycle without bypassing the geometric constraints enforced at the interface boundary.

In an embodiment, the dual-manifold architecture is not limited to the pairing of a single perceptual manifold and a single cognitive manifold. Additional structured manifolds representing other perceptual or operational domains—such as acoustic processing manifolds, robotic control manifolds, or simulation manifolds for alternative physical domains—may each be coupled to the epistemically conditioned cognitive manifold through a respective formally defined interface operator analogous to the bidirectional geometric interface operator described herein. Each such interface operator independently enforces capacity mediation, admissibility gating, structural reconciliation, and reversible journaling appropriate to the geometric properties of its respective manifold pair. The essential architectural feature in each case is the existence of a formally defined, machine-enforced, bidirectional geometric interface operator mediating capacity-and admissibility-constrained state exchange between distinct structured manifolds within the persistent cognitive machine.

In an embodiment, when capacity or admissibility constraints are not satisfied at the interface boundary, the interface operator is not limited to immediate rejection of a candidate transfer. The operator may instead invoke corroborative or refinement processes prior to a renewed transfer attempt. Such processes may include requesting additional perceptual evidence to reduce uncertainty in a candidate inbound state, initiating supplementary reasoning traversal within the cognitive manifold to evaluate whether an alternative admissible path supports the proposed insertion, or applying iterative projection refinement to reduce structural compatibility residuals below admissibility thresholds. Only if corroborative or refinement processes fail to produce a state satisfying the relevant constraints is the transfer abandoned and the event recorded in the journaling subsystem as a rejected transfer with associated diagnostic codes.

In an embodiment, the system may be deployed in safety-critical environments in which the interface boundary serves as a regulatory enforcement point governing the relationship between cognitive reasoning and physical actuation. In such deployments, cognitive decisions intended to produce actuator commands or physical control outputs may not be expressed directly from the cognitive manifold. Instead, any such decision must first be projected into the first latent manifold through the outbound interface pathway and must satisfy the physical plausibility constraints and compression-pressure constraints of that manifold before a corresponding actuator command is permitted. Conversely, perceptual states arising from safety-critical sensor inputs must satisfy admissibility evaluation before influencing high-commitment cognitive states. This dual validation architecture reduces the likelihood of physically impossible control actions, hallucinatory actuator commands, and cross-modal instability propagation in systems operating under regulatory or safety constraints.

In an embodiment, the transformation functions employed by the bidirectional geometric interface operator during structural reconciliation between manifolds may include linear or nonlinear embedding mappings, exponential and logarithmic map approximations relative to local geodesic structure of a target manifold, regularized least-squares projections that minimize reconciliation residuals subject to regularization penalties preventing overfitting to local geometric artifacts, and metric normalization operations that compensate for scale differences between the geometric metrics of the source and target manifolds. The selection among transformation functions may depend on local geometric conditions at the projection site, and in some embodiments the interface operator may apply a combination of such functions in sequence to achieve a projected state satisfying structural compatibility tolerances of the target manifold. The foregoing enumeration of transformation functions is non-limiting, and other projection techniques consistent with the structural reconciliation objectives described herein may be employed.

In an embodiment, states encoded within the first latent manifold may represent correlated multimodal embeddings in which sensor data from heterogeneous sources are fused into a unified latent tensor preserving cross-modal correlation structure, in addition to temporal ordering information, covariance or uncertainty parameters, and spatiotemporal feature relationships. In an embodiment, traversal within the second latent manifold may be implemented through stored adjacency lists encoding neighbor relationships among cognitive states and path stacks maintaining active reasoning trajectory histories, with epistemic phase accumulation and admissibility checks performed at each transition along edges of the stored graph structure. These implementation structures are non-limiting and other data structures suitable for representing manifold connectivity and supporting efficient traversal may be employed.

In a non-limiting use case example, the system is deployed as a persistent cognitive machine monitoring a large-scale industrial facility operating high-pressure chemical processing equipment. A plurality of sensors distributed throughout the facility continuously provide vibration, pressure, thermal, flow, and acoustic telemetry from pumps, reactors, and interconnecting fluid lines. The telemetry ingestion subsystem receives and temporally aligns these sensor streams, encodes them into structured latent tensor representations with associated uncertainty parameters, and writes the resulting states into the first latent manifold. The predictive rollout subsystem computes forward geodesic trajectories from current states, generating predicted future system configurations and their associated uncertainty cones over a configurable prediction horizon. During routine operation, predicted trajectories remain within physically plausible regions of the first latent manifold and no cross-manifold transfer is initiated.

As the facility approaches an abnormal operating condition, pressure and vibration sensors in a reactor feed line begin producing readings that cause a localized region of the first latent manifold to exhibit elevated curvature and rapidly expanding uncertainty cone geometry, indicating an emerging instability precursor. The system identifies this region as a candidate for cognitive escalation and invokes the inbound projection component of the bidirectional geometric interface operator. The interface operator computes a provisional embedding of the anomalous visual state into coordinates compatible with the second latent manifold, performing structural reconciliation to normalize metric scale differences and transforming the Lorentzian uncertainty cone parameters into epistemic confidence attenuation values. The interface capacity mediator evaluates projected post-insertion density relative to local symplectic capacity in the neighborhood of the proposed insertion point and confirms that the threshold is not exceeded. The interface admissibility evaluator computes the structural compatibility residual of the interpolated almost-complex structure at the provisional location, performs phase screening over short closed paths to detect local epistemic inconsistency, and confirms that the provisional location does not conflict with any consolidated reservoir boundary. Both evaluations returning approval, the anomalous state is incorporated into the second latent manifold as a flagged cognitive insertion with reduced commitment pending corroboration.

The reasoning traversal subsystem initiates cognitive trajectory computation from the admitted state, evaluating evidential consistency by accumulating epistemic phase along candidate reasoning paths connecting the anomalous insertion to neighboring cognitive states encoding prior operational experience with similar instability signatures. A closed reasoning path connecting the anomalous state to a region of consolidated knowledge representing known pump cavitation precursors accumulates an epistemic phase magnitude within the coherent regime, permitting consolidation of a structured hypothesis that the detected signature is consistent with early-stage cavitation onset in the reactor feed pump. The reasoning subsystem produces this hypothesis as an epistemically admissible cognitive state eligible for outbound export.

The system determines that predictive simulation of the cavitation hypothesis is warranted and invokes the outbound projection component of the bidirectional geometric interface operator. The interface operator verifies that the hypothesis state is not marked epistemically inadmissible and does not belong to a suppressed trajectory class. The interface capacity mediator estimates the deformation energy induced by embedding the cognitive state into the first latent manifold and confirms that compression-pressure constraints of the first latent manifold would not be violated. The interface admissibility evaluator confirms physical plausibility of the projected state. The cross-manifold uncertainty translation process maps the epistemic phase variance of the hypothesis into probabilistic perturbation envelopes suitable for visual rendering. The projected visual state is written into the first latent manifold, and the predictive rollout subsystem subjects it to Lorentzian geodesic rollout, generating a synthetic video sequence depicting the anticipated evolution of cavitation bubble formation and associated pressure oscillations in the reactor feed line over the subsequent several seconds.

The synthetic video output encodes uncertainty through opacity gradients, rendering high-confidence predicted regions at full opacity and more uncertain regions with graduated transparency, and highlights the predicted cavitation onset region through visual emphasis cues. This output is presented to facility operators, providing actionable advance warning of a potential equipment instability. The cross-manifold journaling subsystem has recorded every transfer event in this sequence with cryptographic verification, preserving reversible traceability from the rendered simulation back through the outbound projection parameters, through the cognitive hypothesis and its reasoning trajectory, through the inbound projection parameters, and ultimately to the original sensor telemetry readings that initiated the escalation sequence. An operator reviewing the simulation may confirm or annotate the predicted outcome, with such feedback re-entering the system through the inbound interface pathway and contributing to subsequent refinement of the consolidated knowledge region associated with cavitation precursor signatures.

The foregoing use case example is non-limiting in nature and is presented solely to illustrate one embodiment of the disclosed architecture in a concrete operational context. Many embodiments and use cases exist across diverse domains in which structured coupling between perceptual prediction and epistemically conditioned reasoning provides technical benefit. Without limitation, the system may be applied to autonomous vehicle perception and decision systems in which sensor-derived trajectory predictions must be validated against epistemically conditioned driving policy before influencing control outputs, to medical diagnostic platforms in which imaging or biosensor data is escalated into structured clinical reasoning with admissibility gating preventing unsupported diagnostic conclusions from reaching treatment recommendations, to financial risk systems in which market telemetry is encoded into predictive manifold dynamics and selectively incorporated into epistemic reasoning over regulatory and historical constraints, to aerospace structural health monitoring in which vibration and acoustic telemetry drives predictive simulation of fatigue progression while cognitive reasoning evaluates evidential consistency against certified material models, and to scientific research platforms in which experimental sensor streams inform hypothesis formation subject to epistemic coherence requirements derived from accumulated domain knowledge. In each such application, the technical effect of the invention is the machine-enforced structural separation of perceptual and epistemic domains with controlled, auditable, capacity-and admissibility-constrained coupling through the bidirectional geometric interface operator, such that neither hallucinated reasoning influences physical simulation nor physically implausible perceptual states contaminate high-commitment cognitive conclusions. The specific geometric formalisms, threshold values, manifold dimensionalities, sensor modalities, and deployment configurations described herein are illustrative and not limiting, and one of ordinary skill in the art will recognize that the architecture may be adapted to any domain in which dual structured latent representations benefit from formally constrained bidirectional interaction. Accordingly, the invention is defined by the claims and their equivalents, and the embodiments described herein are presented for the purpose of illustration rather than limitation.

One or more different aspects may be described in the present application. Further, for one or more of the aspects described herein, numerous alternative arrangements may be described; it should be appreciated that these are presented for illustrative purposes only and are not limiting of the aspects contained herein or the claims presented herein in any way. One or more of the arrangements may be widely applicable to numerous aspects, as may be readily apparent from the disclosure. In general, arrangements are described in sufficient detail to enable those skilled in the art to practice one or more of the aspects, and it should be appreciated that other arrangements may be utilized and that structural, logical, software, electrical and other changes may be made without departing from the scope of the particular aspects. Particular features of one or more of the aspects described herein may be described with reference to one or more particular aspects or figures that form a part of the present disclosure, and in which are shown, by way of illustration, specific arrangements of one or more of the aspects. It should be appreciated, however, that such features are not limited to usage in the one or more particular aspects or figures with reference to which they are described. The present disclosure is neither a literal description of all arrangements of one or more of the aspects nor a listing of features of one or more of the aspects that must be present in all arrangements.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible aspects and in order to more fully illustrate one or more aspects. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the aspects, and does not imply that the illustrated process is preferred. Also, steps are generally described once per aspect, but this does not mean they must occur once, or that they may only occur once each time a process, method, or algorithm is carried out or executed. Some steps may be omitted in some aspects or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other aspects need not include the device itself.

Techniques and mechanisms described or referenced herein will sometimes be described in singular form for clarity. However, it should be appreciated that particular aspects may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various aspects in which, for example, functions may be executed out of order from that shown or discussed, including substantially concurrently or in reverse order, depending on the functionality involved, as would be understood by those having ordinary skill in the art.

### Definitions

As used herein, “admissibility constraint” refers to a structural condition derived from geometric, epistemic, or capacity properties of a latent manifold that must be satisfied before a candidate state may be incorporated into that manifold.

As used herein, “bidirectional geometric interface operator” refers to a machine-implemented operator that mediates structured state exchange between two geometrically distinct latent manifolds, performs structural reconciliation between source and target manifolds, evaluates capacity and admissibility constraints, and conditionally incorporates projected states only when such constraints are satisfied.

As used herein, “capacity constraint” refers to a limitation derived from geometric properties of a latent manifold that bounds representational density, structural deformation, or uncertainty magnitude permitted within a region of that manifold.

As used herein, “cognitive state” refers to a representational configuration encoded as a location within a latent manifold structured under epistemic conditioning and representing a hypothesis, reasoning result, or intermediate cognitive configuration.

As used herein, “cross-manifold journaling” refers to persistent recording of state transfer events between latent manifolds, including source identifiers, target identifiers, transformation parameters, and decision outcomes sufficient to reconstruct transferred states within bounded error tolerances.

As used herein, “epistemic conditioning information” refers to geometric, topological, or phase-related structure embedded within a latent manifold that defines admissibility boundaries, capacity limits, or coherence requirements for reasoning trajectories.

As used herein, “epistemic eligibility constraint” refers to a requirement that a cognitive state satisfy epistemic admissibility conditions before being exported from a cognitive manifold to another manifold.

As used herein, “epistemic phase” refers to an accumulated path-dependent quantity assigned to transitions between cognitive states that reflects evidential consistency or inconsistency along a reasoning trajectory.

As used herein, “geometric metric governing causal ordering” refers to a metric structure on a latent manifold that encodes directional or temporal relationships between encoded states and constrains predictive trajectory computation according to ordering relationships.

As used herein, “geometric reconciliation” or “structural reconciliation” refers to a transformation process that maps a state from a source latent manifold into a coordinate representation compatible with geometric properties of a target latent manifold while preserving defined structural relationships within tolerance bounds.

As used herein, “latent manifold” refers to a geometric representational substrate in which encoded states correspond to locations and transitions between states correspond to paths governed by stored geometric structure.

As used herein, “Lorentzian signature” refers to a pseudo-Riemannian metric signature comprising at least one component of opposite sign relative to remaining components, enabling representation of directional or temporal ordering within a latent manifold.

As used herein, “perceptually derived state” refers to a state encoded from sensor data, telemetry, or other external inputs and represented within a latent manifold structured for spatiotemporal or predictive modeling.

As used herein, “physical plausibility constraint” refers to a condition derived from geometric properties of a perceptual or predictive latent manifold that restricts incorporation of states that would violate modeled physical, causal, or structural limits.

As used herein, “predictive trajectory computation” refers to determination of a future state or sequence of states within a latent manifold based on stored metric and connection properties governing allowable paths.

As used herein, “reversible mapping” refers to storage of sufficient transformation parameters and identifiers to permit reconstruction of a projected state to a corresponding source state within bounded reconstruction error.

As used herein, “spatiotemporal state” refers to a representation within a latent manifold that encodes temporal ordering relationships and spatial or feature relationships derived from perceptual input.

As used herein, “structurally incompatible state” refers to a projected state whose incorporation into a target latent manifold would violate capacity, admissibility, or geometric compatibility constraints.

As used herein, “uncertainty translation” refers to transformation of uncertainty representations from one latent manifold into uncertainty representations compatible with geometric and operational properties of another latent manifold while preserving monotonic relationships between uncertainty magnitudes.

### Conceptual Architecture of a Dual-Manifold Persistent Cognitive Machine

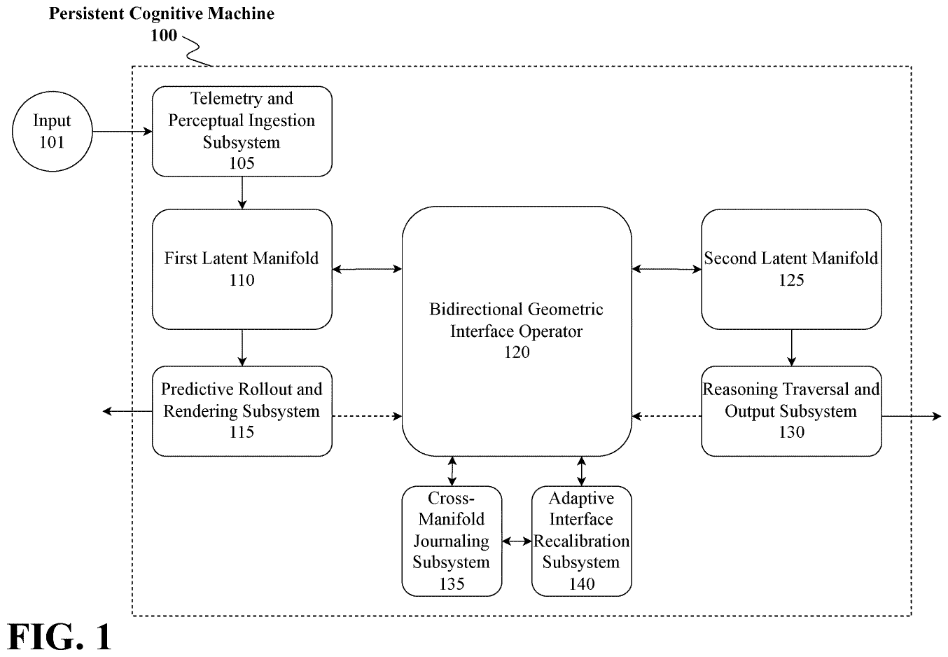

FIG. 1 is a block diagram illustrating an exemplary architecture of a persistent cognitive machine (PCM) 100 comprising two geometrically distinct latent manifolds maintained concurrently in hardware memory and coupled through a bidirectional geometric interface operator that serves as an exclusive pathway for cross-manifold state exchange, in an embodiment. The system 100 comprises a perceptual domain and an epistemic domain implemented as discrete data structures stored in hardware memory and operated upon by one or more processors. A telemetry and perceptual ingestion subsystem 105, a first latent manifold 110, and a predictive rollout and rendering subsystem 115 are arranged on a first side of an interface boundary corresponding to the perceptual domain. A second latent manifold 125 and a reasoning traversal and output subsystem 130 are arranged on a second side corresponding to the epistemic domain. A cross-manifold journaling subsystem 135 and an adaptive interface recalibration subsystem 140 are logically coupled to the bidirectional geometric interface operator 120.

External sensor and telemetry inputs 101 represent heterogeneous incoming data stream. A telemetry and perceptual ingestion subsystem 105 receives those inputs, applies modality-specific signal conditioning, and encodes the conditioned data into structured latent tensor representations with associated uncertainty parameters. The resulting encoded states are written into a first latent manifold 110, which is structured under a pseudo-Riemannian metric of Lorentzian signature and is configured to support geodesic trajectory computation and uncertainty representation through causal cone structures. A predictive rollout and rendering subsystem 115 receives states from the first latent manifold 110, computes forward geodesic trajectories under the stored metric and connection structure, generates probabilistic future state representations, and produces synthetic visual output, indicated by a labeled terminus at the base of the subsystem 115. States selected from the first latent manifold 110, including states identified by the predictive rollout and rendering subsystem 115 as exhibiting elevated uncertainty or anomalous curvature characteristics, may be forwarded to a bidirectional geometric interface operator 120 via a secondary data path.

The operator 120 may comprise an inbound projection component, an outbound projection component, an interface capacity mediator, an interface admissibility evaluator, and a cross-manifold uncertainty translation process. The operator 120 enforces cross-manifold compatibility derived from distinct geometric formalisms governing the first latent manifold 110 and the second latent manifold 125. For inbound transfer, a visual or perceptual state is received from the first latent manifold 110 along an upper arrow, and a projected cognitive state is conditionally issued to the second latent manifold 125 along a corresponding upper arrow on the opposing side. For outbound transfer, a cognitive state is received from the second latent manifold 125 along a lower arrow, and a projected visual state is conditionally returned to the first latent manifold 110 along a corresponding lower arrow. States that do not satisfy capacity, admissibility, epistemic eligibility, or physical plausibility constraints evaluated by the operator 120 are not incorporated into a respective target manifold.

A second latent manifold 125 is structured under an almost-Kähler geometry with epistemic conditioning and is configured to encode cognitive states, reasoning trajectories, and consolidated knowledge regions subject to capacity and admissibility constraints. Admitted states flow from the second latent manifold 125 downward to a reasoning traversal and output subsystem 130, which is configured to traverse the second latent manifold 125 to evaluate candidate reasoning paths, accumulate epistemic phase along transitions, manage consolidation and suppression of trajectories, and generate outputs conditioned on admissibility status. The reasoning traversal and output subsystem 130 may forward selected cognitive states for visual simulation to the bidirectional geometric interface operator 120. Outputs generated by the reasoning traversal and output subsystem 130 exit the system 100 through a labeled external output terminus.

The cross-manifold journaling subsystem 135 and the adaptive interface recalibration subsystem 140 may be coupled to the bidirectional geometric interface operator 120 in various embodiments. The operator 120 forwards transfer event records to the cross-manifold journaling subsystem 135, which maintains a cryptographically chained record of cross-manifold transfer events including source and target coordinates, transformation parameters, and capacity and admissibility decision codes. The cross-manifold journaling subsystem 135 provides historical transfer records to the adaptive interface recalibration subsystem 140, which periodically evaluates projection performance relative to current geometric properties of the first latent manifold 110 and the second latent manifold 125 and issues updated capacity thresholds, projection norms, and structural compatibility mappings back to the operator 120.

In an exemplary data flow sequence, external sensor and telemetry inputs 101 are received and conditioned by a telemetry and perceptual ingestion subsystem 105, which encodes the inputs into structured latent tensor representations and writes the resulting states into a first latent manifold 110. A predictive rollout and rendering subsystem 115 retrieves states from the first latent manifold 110 and computes forward geodesic trajectories, generating predicted future states with associated uncertainty representations. When a state exhibiting elevated curvature or expanding uncertainty cone geometry is identified as a candidate for cognitive escalation, a secondary data path carries that state from the predictive rollout and rendering subsystem 115 to a bidirectional geometric interface operator 120, which applies structural reconciliation, evaluates interface-level capacity and admissibility constraints, translates uncertainty representations into epistemic confidence measures, and, upon approval, writes a projected cognitive state into a second latent manifold 125. A reasoning traversal and output subsystem 130 receives the admitted state from the second latent manifold 125, computes reasoning trajectories under epistemic phase monitoring, and may produce a cognitive hypothesis eligible for outbound export. That hypothesis is forwarded via a secondary data path to the operator 120, which verifies epistemic eligibility and physical plausibility constraints, and upon approval computes a projected visual state that is written into the first latent manifold 110 and forwarded to the predictive rollout and rendering subsystem 115 for geodesic rollout and synthetic visual output. Each transfer event in this sequence is recorded by a cross-manifold journaling subsystem 135, and the resulting historical records are periodically evaluated by an adaptive interface recalibration subsystem 140, which issues updated parameters to the operator 120.

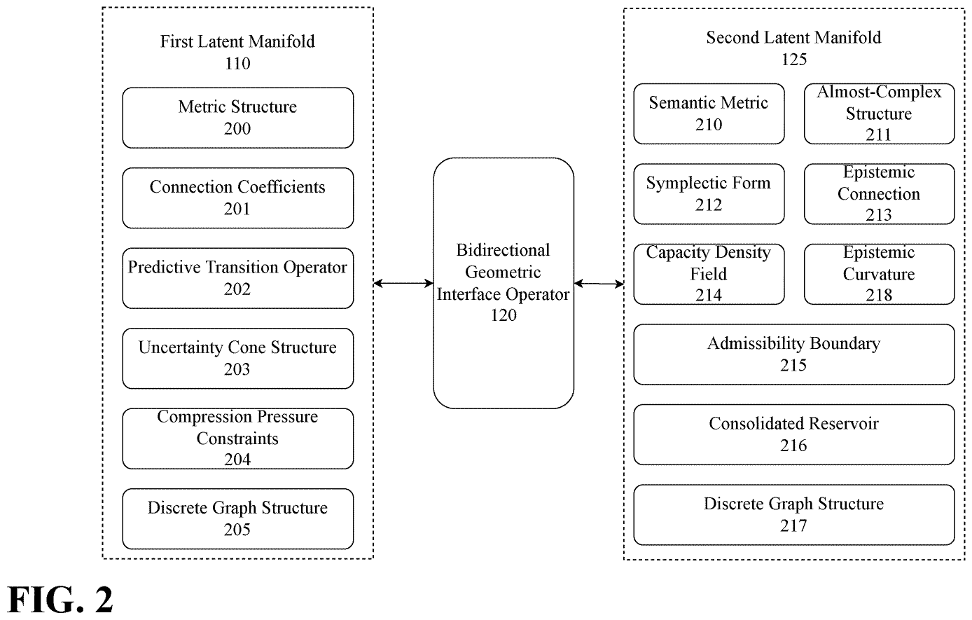

FIG. 2 is a block diagram illustrating an exemplary internal architecture of a first latent manifold 110 and a second latent manifold 125 within a persistent cognitive machine 100, together with a bidirectional geometric interface operator 120 that couples them, in an embodiment. The two manifolds are geometrically distinct representational substrates maintained concurrently as data structures in hardware memory and operated upon by one or more processors, and are coupled through the interface operator 120. The first latent manifold 110 is structured under a pseudo-Riemannian metric of Lorentzian signature and encodes spatiotemporal and perceptually derived states supporting causal ordering and predictive trajectory computation. The second latent manifold 125 is structured under almost-Kähler geometry with epistemic conditioning and encodes cognitive states, reasoning trajectories, and consolidated knowledge subject to capacity and admissibility constraints. The geometric formalisms governing the first latent manifold 110 and the second latent manifold 125 are not metrically compatible, and direct concatenation or unrestricted state transfer between them does not occur; all cross-manifold transfers occur through structural reconciliation enforced by the bidirectional geometric interface operator 120.

A metric structure 200 encodes the pseudo-Riemannian metric tensor gv and defines causal ordering relationships among perceptual states within the first latent manifold 110. The metric structure 200 governs a set of connection coefficients 201, which represent Christoffel symbols Γkij associated with transitions between adjacent vertices of the manifold graph and govern geodesic trajectory transitions between states. The connection coefficients 201 in turn govern a predictive transition operator 202 that computes forward geodesic state evolution mapping Mv(t) to Mv(t+Δt). The predictive transition operator 202 generates an uncertainty cone structure 203 representing covariance Σ associated with a predicted state, with cone width proportional to prediction horizon under forward rollout. Operation of the predictive transition operator 202 occurs subject to a compression-pressure constraint 204, which encodes local metric deformation penalties and modifies geodesic update parameters to restrict predicted trajectories to physically plausible regions of the manifold. The compression-pressure constraint 204 supplies regulatory feedback to the predictive transition operator 202, forming a closed loop over geodesic computation. The metric structure 200 and connection coefficients 201 are represented within a discrete graph structure 205, which models the manifold as Gv=(Vv, Ev, Fv), with vertices corresponding to perceptual states and edges carrying metric and connection data, and which serves as the implementation substrate over which the predictive transition operator 202 operates.

Within the second latent manifold 125, a semantic metric 210 encodes semantic dissimilarity between cognitive states as edge weights over a cognitive state graph, and an almost-complex structure 211 assigns a linear map J at each vertex satisfying J²=−Id, constraining admissible geometric deformations of the manifold. The semantic metric 210 and almost-complex structure 211 contribute to a symplectic form 212 reconstructed under a compatibility relation ω(X, Y)=gc(JX, Y), which defines local symplectic capacity measures over the manifold. The symplectic form 212 governs a capacity density field 214 that computes a ratio ρω of local state count to symplectic capacity and determines whether a candidate state insertion would exceed a stored capacity threshold. Independently, an epistemic connection 213 assigns transition-specific phase values θij to directed edges of the cognitive state graph, and its discrete curvature F=dA, computed per face, is maintained as an epistemic curvature 218 encoding evidential consistency across the manifold. The semantic metric 210, epistemic connection 213, and epistemic curvature 218 are represented within a discrete graph structure 217 modeling the manifold as Gc=(Vc, Ec, Fc), with vertices corresponding to cognitive states and edges and faces carrying gc, A, θ, and F, and serving as the implementation substrate for reasoning traversal and admissibility evaluation.

The capacity density field 214 and epistemic curvature 218 provide inputs to an admissibility boundary 215, which evaluates candidate states against capacity thresholds and structural compatibility conditions and assigns outcome codes including absorb, flag, defect, and veto. States satisfying admissibility and phase flatness conditions may progress to a consolidated reservoir 216, which maintains irreversible storage of knowledge regions satisfying barrier energy conditions. The consolidated reservoir 216 is represented within the discrete graph structure 217 and participates in subsequent reasoning traversal and admissibility evaluation processes. An absorb outcome permits the projected state to be incorporated into the active cognitive state space as a participant in ongoing reasoning traversal, a flag outcome permits incorporation with reduced commitment pending corroboration, a defect outcome records a boundary violation without incorporation, and a veto outcome excludes the candidate state from the target manifold entirely. The consolidated reservoir 216, represented within the discrete graph structure 217 as a subgraph of phase-flat vertices and edges satisfying barrier energy conditions, may be accessed during reasoning traversal as a source of prior consolidated knowledge against which newly admitted states are evaluated for evidential consistency.

In an exemplary data flow, a perceptual state encoded into the first latent manifold 110 is associated with metric and connection data represented within the discrete graph structure 205. The predictive transition operator 202 computes a forward geodesic trajectory from that state, producing a predicted future state with an associated uncertainty cone structure 203. If the predicted trajectory approaches a region penalized by the compression-pressure constraint 204, the constraint modifies the transition parameters of the predictive transition operator 202 to deflect the trajectory toward physically plausible regions. A candidate state selected for cross-manifold transfer is passed to the bidirectional geometric interface operator 120, which performs structural reconciliation between the geometric conventions of the first latent manifold 110 and those of the second latent manifold 125, applies interface-level capacity mediation and admissibility evaluation, and translates uncertainty representations between manifold conventions. Upon approval, the projected state is incorporated into the second latent manifold 125, where it is further evaluated against the capacity density field 214 and epistemic curvature 218 before receiving an admissibility outcome code from the admissibility boundary 215. States receiving an absorb outcome may contribute to reasoning traversal and, if phase flatness and barrier energy conditions are satisfied, may be committed to the consolidated reservoir 216 and represented within the discrete graph structure 217 for future reference.

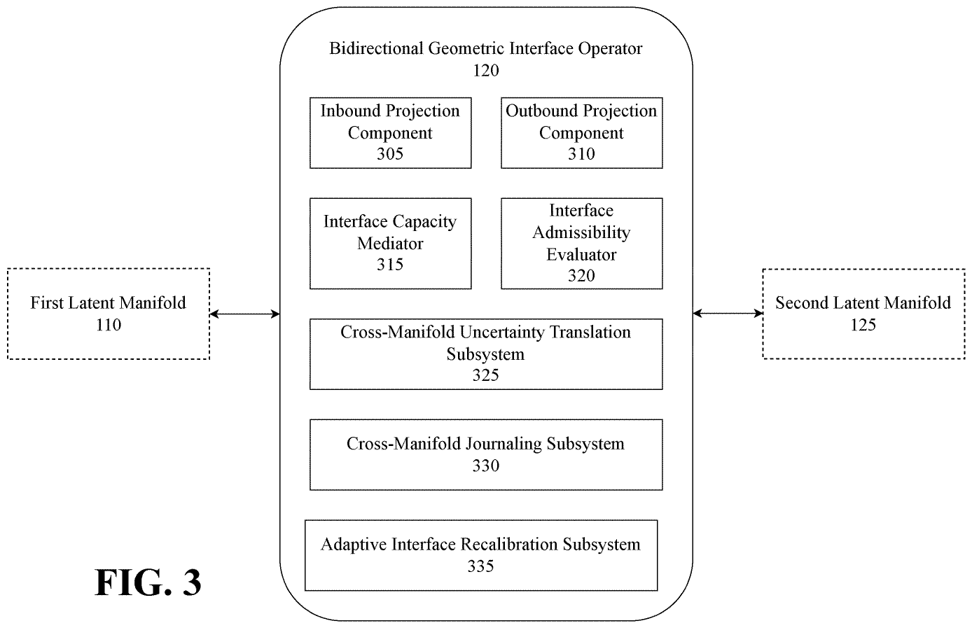

FIG. 3 is a block diagram illustrating an exemplary architecture of a bidirectional geometric interface operator 120 of a PCM 100, in an embodiment. The operator 120 is positioned between a first latent manifold (Mv) and a second latent manifold (Mc), and comprises a collection of subsystems that collectively regulate cross-manifold state exchange. The first latent manifold is structured under Lorentzian visual geometry and the second latent manifold is structured under epistemic cognitive geometry. The operator 120 enforces structural compatibility, capacity constraints, and admissibility constraints at a boundary between these geometrically distinct representational substrates. All cross-manifold transfers are routed through the operator 120, which defines a computational boundary that constrains reachable machine states and prevents uncontrolled propagation of structurally incompatible representations between perceptual and epistemic domains.

An inbound projection component 305 receives visual states from the first latent manifold and computes provisional cognitive embeddings compatible with geometric properties of the second latent manifold. The component 305 applies structural reconciliation operations that map Lorentzian tensor representations into coordinate representations compatible with a semantic metric of the second latent manifold, normalize scale differences between metric structures, preserve temporal ordering derived from causal structure, and project candidate states into a local tangent approximation of the second latent manifold. The resulting provisional embeddings are forwarded for further evaluation prior to any incorporation into the second latent manifold. The component 305 defines a visual-to-cognitive projection pathway that prepares candidate states for interface-level capacity and admissibility analysis.

An outbound projection component 310 receives cognitive states from the second latent manifold and computes projected visual states compatible with geometric properties of the first latent manifold. The component 310 verifies epistemic eligibility of candidate cognitive states based on stored admissibility indicators, applies exponential or logarithmic map functions relative to local geodesic structure of the first latent manifold, preserves causal ordering and temporal coherence conditions, and computes projected states constrained to regions that satisfy compression-pressure limitations of the first latent manifold. The resulting projected visual states are forwarded for further evaluation prior to any incorporation into the first latent manifold. The component 310 defines a cognitive-to-visual projection pathway that prepares candidate states for interface-level capacity and admissibility analysis under physical plausibility constraints.

The interface capacity mediator 315 receives provisional embeddings from the inbound projection component 305 and projected visual states from the outbound projection component 310 and computes quantitative capacity metrics derived from geometric structures of a respective target manifold. For inbound transfers, the mediator 315 computes a projected post-insertion density relative to local symplectic capacity in a neighborhood of a provisional insertion location in the second latent manifold and compares the computed density to a stored interface capacity threshold. For outbound transfers, the mediator 315 computes a deformation energy induced by embedding a cognitive state into the first latent manifold and verifies that the projected state satisfies compression-pressure constraints encoded in the first latent manifold. Based on these computed measures, the mediator 315 issues capacity decision codes including approval, veto, attenuation, or provisional status for each candidate transfer. By bounding representational density and deformation energy at the manifold boundary, the mediator 315 limits uncontrolled growth or destabilization of either manifold.

The interface admissibility evaluator 320 receives provisional embeddings from the inbound projection component 305 and projected visual states from the outbound projection component 310 and computes compatibility and coherence measures derived from geometric and epistemic constraints of a respective target manifold. For inbound transfers, the evaluator 320 computes structural compatibility residuals by comparing interpolated geometric structures at a provisional insertion location against corresponding structures at neighboring locations, performs phase-consistency screening over bounded closed paths to detect local epistemic inconsistency, and determines whether the provisional location conflicts with stored admissibility boundaries or consolidated reservoir boundaries of the second latent manifold. For outbound transfers, the evaluator 320 verifies that a candidate cognitive state is not marked epistemically inadmissible and does not belong to a suppressed reasoning trajectory class. Based on the computed compatibility and coherence measures, the evaluator 320 issues admissibility outcome codes including absorb, flag, defect, veto, or pending corroboration for each candidate transfer. Through this computation, structurally incompatible or epistemically invalid states are prevented from crossing the interface boundary.

A cross-manifold uncertainty translation subsystem 325 transforms uncertainty representations between geometric conventions of the first latent manifold and the second latent manifold. The subsystem 325 receives uncertainty parameters associated with candidate transfers, including covariance structures, uncertainty cone parameters, phase variance values, and admissibility confidence levels, and computes manifold-specific uncertainty encodings using transformation rules that preserve defined monotonic relationships between source and target uncertainty magnitudes. For inbound transfers, Lorentzian uncertainty structures are transformed into epistemic confidence attenuation or phase variance values compatible with epistemic conditioning of the second latent manifold. For outbound transfers, epistemic uncertainty measures are transformed into visual uncertainty encodings including opacity gradients, branching trajectory overlays, and probabilistic perturbation envelopes suitable for predictive rollout within the first latent manifold. The uncertainty translation subsystem 325 operates in coordination with projection and evaluation stages to ensure that uncertainty semantics remain consistent across manifold boundaries.

A cross-manifold journaling subsystem 330 receives transfer event records from the inbound projection component 305, the outbound projection component 310, the interface capacity mediator 315, the interface admissibility evaluator 320, and the cross-manifold uncertainty translation subsystem 325. The subsystem 330 records source manifold coordinates, target manifold coordinates, transformation parameters, computed capacity metrics, admissibility outcome codes, uncertainty translation parameters, timestamps, and cryptographic hashes linking successive records in a tamper-evident chain. The subsystem 330 maintains a persistent record of cross-manifold transfers sufficient to reconstruct projected states to corresponding source states within defined reconstruction error tolerances. The journaling mechanism provides machine-enforced traceability between perception, reasoning, and simulation and supports auditing of interface boundary decisions.

The adaptive interface recalibration subsystem 335 receives historical transfer records from the cross-manifold journaling subsystem 330 and periodically analyzes projection performance relative to current geometric properties of the first latent manifold and the second latent manifold. In an embodiment, recalibration may consider metrics including approval-to-rejection ratios, reconstruction error magnitudes, frequency of capacity threshold violations, and manifold growth rates. Based on these computed measures, the subsystem 335 updates interface capacity thresholds, projection norms, and structural compatibility mappings. Updated parameters are written back to the inbound projection component 305, the outbound projection component 310, the interface capacity mediator 315, and the interface admissibility evaluator 320. The subsystem 335 operates on a background timescale distinct from real-time transfer events and may be invoked during consolidation or low-activity periods to maintain stable cross-manifold interaction as manifold structures evolve.

In an exemplary inbound data flow sequence, a visual state from the first latent manifold enters the inbound projection component 305, which computes a provisional cognitive embedding through structural reconciliation operations. The provisional embedding, together with associated uncertainty parameters, is forwarded to the interface capacity mediator 315 and the interface admissibility evaluator 320. The mediator 315 computes projected density relative to symplectic capacity of the second latent manifold, and the evaluator 320 computes compatibility residuals and phase-consistency measures. The cross-manifold uncertainty translation subsystem 325 transforms Lorentzian covariance structures into epistemic confidence measures for use within the second latent manifold. The cross-manifold journaling subsystem 330 records transformation parameters and decision codes from each evaluation stage. When both capacity and admissibility computations produce approval codes, the projected cognitive state is incorporated into the second latent manifold, and the complete transfer event is cryptographically linked to prior records.

In an exemplary outbound data flow sequence, a cognitive state from the second latent manifold enters the outbound projection component 310, which verifies epistemic eligibility and computes a projected visual state consistent with geodesic structure of the first latent manifold. The projected state and associated uncertainty parameters are forwarded to the interface capacity mediator 315 and the interface admissibility evaluator 320. The mediator 315 computes deformation energy and verifies compliance with compression-pressure constraints, and the evaluator 320 confirms admissibility status. The uncertainty translation subsystem 325 maps epistemic phase variance into visual uncertainty encodings for predictive rollout. When both capacity and admissibility computations produce approval codes, the projected visual state is incorporated into the first latent manifold and becomes eligible for predictive simulation, with the journaling subsystem 330 recording the complete outbound transfer event.

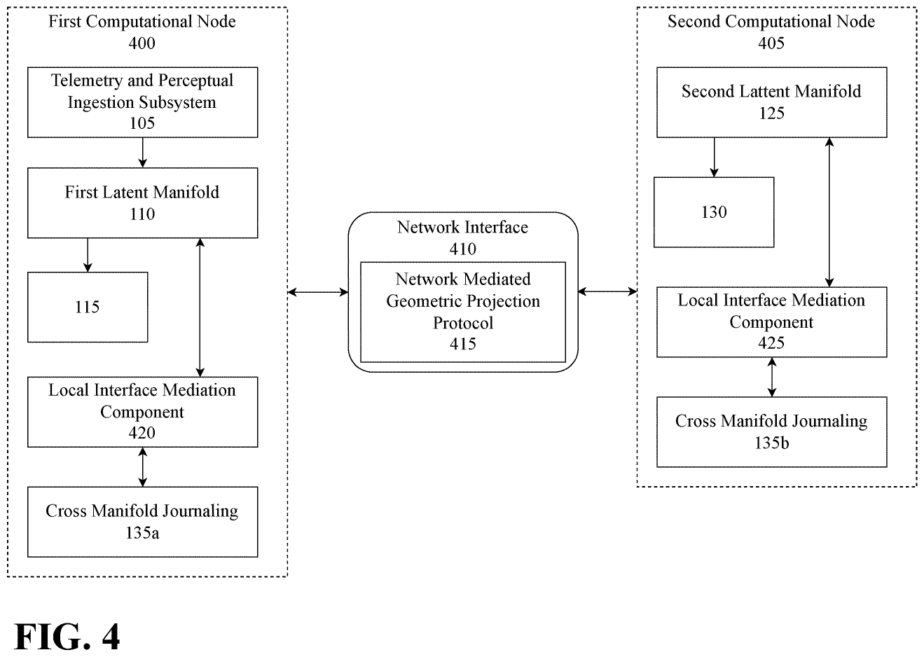

FIG. 4 is a block diagram illustrating exemplary architecture of a distributed deployment configuration of a PCM 100, in an embodiment. In this configuration, a first latent manifold 110 and a second latent manifold 125 are maintained on separate computational nodes rather than within a single computing device. A first computational node 400 maintains a first latent manifold 110 structured under a pseudo-Riemannian metric of Lorentzian signature, together with a telemetry and perceptual ingestion subsystem 105 and a predictive rollout and rendering subsystem 115. A second computational node 405 maintains a second latent manifold 125 structured under almost-Kähler geometry with epistemic conditioning, together with a reasoning traversal and output subsystem 130. A bidirectional geometric interface operator 120 is logically distributed across a first computational node 400 and a second computational node 405, with a local interface mediation component 420 executing on a first computational node 400, a local interface mediation component 425 executing on a second computational node 405, and a network-mediated geometric projection protocol 415 mediating transfer between them through a network interface 410. A local interface mediation component 420 and a local interface mediation component 425 are each constituent instances of a bidirectional geometric interface operator 120, each performing the subset of interface operator functions that require access to geometric structures of a respective co-located manifold.

A first computational node 400 receives external sensor and telemetry inputs 101, which are conditioned and encoded by a telemetry and perceptual ingestion subsystem 105 into structured latent tensor representations written into a first latent manifold 110. A predictive rollout and rendering subsystem 115 computes forward geodesic trajectories from states in a first latent manifold 110 and produces synthetic visual output. When a state is selected for cross-manifold transfer from a first latent manifold 110, a local interface mediation component 420 performs structural reconciliation to map the state into a coordinate representation compatible with geometric properties of a second latent manifold 125 and applies a pre-transmission capacity evaluation to enforce bounded transfer volume before the structured representation crosses a network interface 410. When a structured representation arrives at a first computational node 400 from a second computational node 405, a local interface mediation component 420 computes deformation energy and verifies that the projected state satisfies compression-pressure constraints encoded in the first latent manifold 110 and evaluates physical plausibility constraints before conditionally incorporating a projected visual state into a first latent manifold 110.

A second computational node 405 receives structured latent state representations from a network interface 410 through a local interface mediation component 425. When a structured representation arrives from a first computational node 400, a local interface mediation component 425 evaluates target-manifold capacity against local symplectic capacity of a second latent manifold 125 and computes compatibility residuals, phase-consistency measures, and boundary conflict indicators derived from geometric properties of the second latent manifold 125, including structural compatibility residuals, phase-consistency screening, and consolidated reservoir boundary detection, before conditionally incorporating a projected cognitive state into a second latent manifold 125. A reasoning traversal and output subsystem 130 receives admitted states from a second latent manifold 125, computes reasoning trajectories under epistemic phase monitoring, and generates external output conditioned on admissibility status. When a cognitive state is selected for outbound export, a local interface mediation component 425 verifies epistemic eligibility, performs structural reconciliation to map the state into a coordinate representation compatible with geometric properties of a first latent manifold 110, and applies a pre-transmission capacity evaluation before forwarding the structured representation through a network interface 410 to a first computational node 400.

A network-mediated geometric projection protocol 415 transfers structured latent state representations and associated metadata between a first computational node 400 and a second computational node 405. Raw perceptual data residing within a first latent manifold 110 and internal reasoning trajectories residing within a second latent manifold 125 are not transmitted across a network interface 410. Each computational node maintains a respective instance of a cross-manifold journaling subsystem, with a cross-manifold journaling subsystem 135a on a first computational node 400 and a cross-manifold journaling subsystem 135b on a second computational node 405. Each instance records transfer events including source coordinates, target coordinates, transformation parameters, capacity and admissibility decision codes, and cryptographic hashes linking successive records, supporting reconstruction of projected states to corresponding source states within defined reconstruction error tolerances, thereby enabling reconstruction of projected states across node boundaries using stored transformation parameters and cryptographic linkage.

In an exemplary data flow sequence, external sensor and telemetry inputs 101 are received by a telemetry and perceptual ingestion subsystem 105 on a first computational node 400, which encodes the inputs into structured latent tensor representations and writes the resulting states into a first latent manifold 110. A predictive rollout and rendering subsystem 115 computes forward geodesic trajectories from current states and identifies a candidate state exhibiting elevated uncertainty or anomalous curvature characteristics for cognitive escalation. The candidate state is forwarded to a local interface mediation component 420, which performs structural reconciliation, evaluates pre-transmission capacity, and upon approval transmits a structured latent state representation and associated metadata through a network interface 410 via a network-mediated geometric projection protocol 415 to a second computational node 405. A local interface mediation component 425 on a second computational node 405 receives the structured representation, evaluates target-manifold capacity against local symplectic capacity of a second latent manifold 125, evaluates admissibility constraints derived from geometric properties of a second latent manifold 125, and upon satisfaction of those constraints incorporates a projected cognitive state into a second latent manifold 125, with a cross-manifold journaling subsystem 135b recording the inbound transfer event. A reasoning traversal and output subsystem 130 computes reasoning trajectories from the admitted state and produces a cognitive hypothesis eligible for outbound export. The hypothesis is forwarded to a local interface mediation component 425, which verifies epistemic eligibility, performs structural reconciliation, evaluates pre-transmission capacity, and upon approval transmits the structured representation through a network interface 410 to a first computational node 400. A local interface mediation component 420 receives the structured representation, evaluates target-manifold capacity against compression-pressure constraints of a first latent manifold 110, evaluates physical plausibility constraints, and upon approval incorporates a projected visual state into a first latent manifold 110 for geodesic rollout and rendering by a predictive rollout and rendering subsystem 115, with a cross-manifold journaling subsystem 135a recording the outbound transfer event. By partitioning interface enforcement across computational nodes and constraining transfer at both transmission and reception stages, the distributed configuration reduces destabilizing cross-node feedback loops and limits propagation of structurally incompatible state representations across network boundaries.

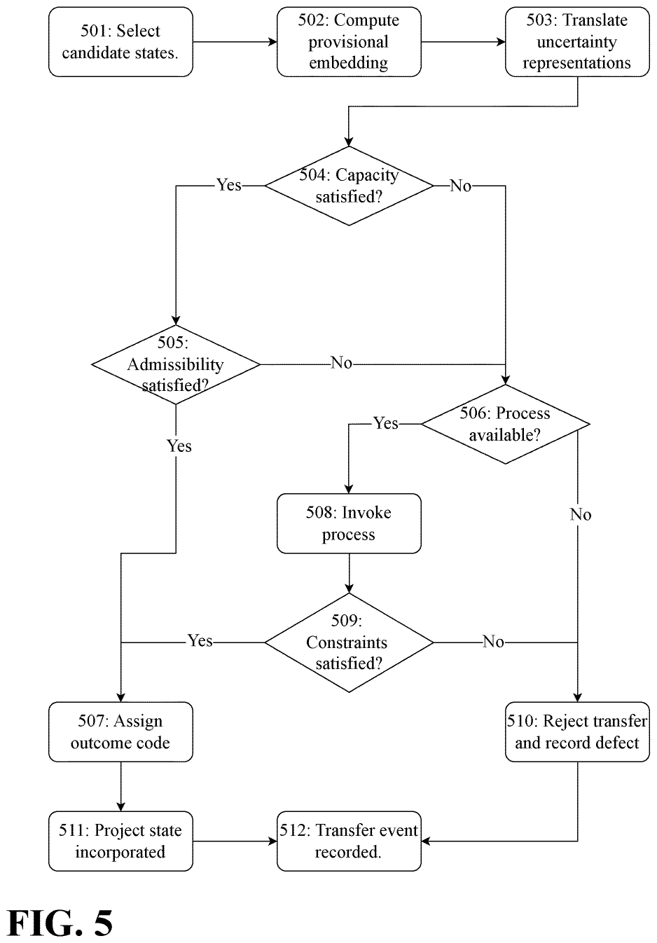

FIG. 5 is a flow diagram illustrating exemplary inbound projection flow of a dual manifold PCM 100, in an embodiment. The flow begins when a candidate state is selected from the first latent manifold 110 for cross-manifold transfer, where the candidate state may correspond to a current perceptual embedding, a predicted future state generated by the predictive rollout and rendering subsystem 115, a region exhibiting uncertainty magnitude exceeding a stored uncertainty threshold, or a state flagged as anomalous 501.

The inbound projection component 305 of the bidirectional geometric interface operator 120 receives the candidate state and computes a provisional cognitive embedding through structural reconciliation operations that map the Lorentzian tensor representation into coordinates compatible with the semantic metric of the second latent manifold 125, normalize scale differences between the metric structures of the first latent manifold 110 and the second latent manifold 125, and preserve temporal ordering derived from causal structure of the first latent manifold 110 502. The reconciliation may include projection into a local tangent approximation of the second latent manifold 125 while preserving defined structural relationships within tolerance bounds.

The cross-manifold uncertainty translation subsystem 325 receives uncertainty parameters associated with the candidate state, including covariance structures or uncertainty cone parameters, and computes corresponding epistemic confidence attenuation or phase variance values compatible with epistemic conditioning of the second latent manifold 125, preserving monotonic relationships between source and target uncertainty magnitudes 503.

The interface capacity mediator 315 computes a projected post-insertion density relative to local symplectic capacity in a neighborhood of the provisional insertion location in the second latent manifold 125 and compares the computed density to a stored interface capacity threshold 504. In an embodiment, projected density may be derived from a ratio of anticipated local state count to a symplectic capacity measure computed from the symplectic form associated with the second latent manifold 125. When the capacity computation indicates compliance with the stored threshold, the flow proceeds to admissibility computation.

The interface admissibility evaluator 320 computes compatibility and coherence measures for the provisional cognitive embedding, including structural compatibility residuals of the interpolated almost-complex structure at the provisional insertion location, phase-consistency measures obtained by accumulating epistemic phase over bounded closed paths to detect local epistemic inconsistency, identification of degeneracy regions characterized by epistemic curvature exceeding a stored threshold, and detection of conflicts between the provisional insertion location and admissibility boundaries or consolidated reservoir boundaries of the second latent manifold 125 505. When either the capacity computation at step 504 or the admissibility computation at step 505 indicates non-compliance with stored thresholds or boundary conditions, the bidirectional geometric interface operator 120 determines whether a predefined corroborative or refinement procedure corresponding to the detected constraint condition is defined in stored interface rules 506.

When a corroborative or refinement procedure is defined, the bidirectional geometric interface operator 120 invokes the procedure, which may include requesting additional perceptual evidence to reduce uncertainty in the candidate state, initiating supplementary reasoning traversal within the second latent manifold 125 to evaluate whether an alternative admissible reasoning path supports the proposed insertion, or applying iterative projection refinement to reduce structural compatibility residuals below admissibility tolerances 508. Following execution of the corroborative or refinement procedure, the bidirectional geometric interface operator 120 repeats the capacity computation of step 504 and the admissibility computation of step 505 using updated state representations or updated projection parameters 509. When the computed measures satisfy the relevant thresholds following refinement, the flow proceeds to outcome code assignment at step 507. When the computed measures remain outside defined tolerances after refinement, or when no predefined corroborative or refinement procedure is defined at step 506, the bidirectional geometric interface operator 120 rejects the transfer and records a boundary defect event including diagnostic codes identifying the specific constraint condition that prevented incorporation 510.

When both the capacity computation and the admissibility computation indicate compliance with stored thresholds and boundary conditions, whether initially or following a corroborative or refinement procedure, the interface admissibility evaluator 320 assigns an outcome code to the projected state, where the outcome code may comprise absorb for full incorporation or flag for incorporation with reduced commitment pending corroboration 507. The projected cognitive state is then incorporated into the second latent manifold 125 with the assigned outcome code, and the incorporated state becomes eligible for reasoning traversal by the reasoning traversal and output subsystem 130 511.

Upon completion of the inbound projection flow, whether resulting in incorporation at step 511 or rejection at step 510, the cross-manifold journaling subsystem 330 records the complete transfer event including source manifold coordinates, target manifold coordinates, transformation parameters, uncertainty translation parameters, computed capacity metrics, admissibility outcome codes or defect identifiers, a timestamp, and a cryptographic hash linking the record to the preceding entry in a tamper-evident chain 512. In an embodiment, journaling occurs irrespective of outcome, thereby preserving traceability of both successful incorporations and rejected transfer attempts within defined reconstruction error tolerances.

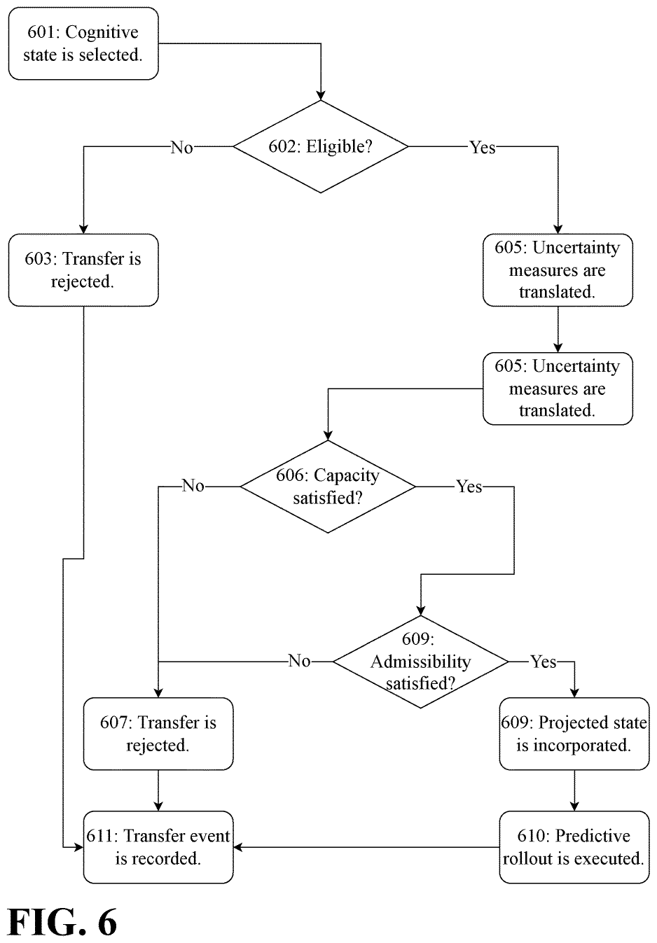

FIG. 6 is a flow diagram illustrating exemplary outbound projection flow of a dual manifold PCM 100, in an embodiment. The flow begins when a cognitive state is selected from the second latent manifold 125 for cross-manifold transfer, where the cognitive state may correspond to a hypothesis reached through admissible reasoning, a consolidated knowledge region, or a trajectory endpoint produced by the reasoning traversal and output subsystem 130 601.

The outbound projection component 310 of the bidirectional geometric interface operator 120 receives the candidate cognitive state and computes epistemic eligibility indicators by determining whether the state is marked epistemically inadmissible, whether the state belongs to a suppressed reasoning trajectory class, and whether the state satisfies stored capacity thresholds governing export from the second latent manifold 125 602.

When the candidate cognitive state does not satisfy the epistemic eligibility conditions at step 602, the bidirectional geometric interface operator 120 rejects the transfer and the state is not projected into the first latent manifold 110, thereby maintaining logical isolation between epistemically inadmissible cognitive states and perceptual simulation or actuator pathways 603.

When the candidate cognitive state satisfies the epistemic eligibility conditions, the outbound projection component 310 computes a projected visual state in the first latent manifold 110 using exponential or logarithmic map functions relative to local geodesic structure of the first latent manifold 110. The projection preserves causal ordering and temporal coherence conditions defined by the pseudo-Riemannian metric and constrains the projected state to regions that satisfy stored geometric compatibility tolerances of the first latent manifold 110 604.

The cross-manifold uncertainty translation subsystem 325 receives epistemic uncertainty measures associated with the candidate cognitive state, including phase variance and admissibility confidence levels, and computes corresponding visual uncertainty encodings including opacity gradients, branching trajectory overlays, and probabilistic perturbation envelopes suitable for predictive rollout within the first latent manifold 110, preserving monotonic relationships between epistemic and visual uncertainty magnitudes 605.

The interface capacity mediator 315 computes a deformation energy induced by embedding the cognitive state into the first latent manifold 110 and compares the computed deformation energy to stored compression-pressure thresholds encoded in the first latent manifold 110 606. When the deformation energy exceeds the stored threshold or when compression-pressure constraints are not satisfied, the bidirectional geometric interface operator 120 rejects the transfer and records a boundary defect event including diagnostic codes identifying the specific constraint condition that prevented incorporation 607.

When the deformation energy and compression-pressure constraints satisfy stored thresholds at step 606, the interface admissibility evaluator 320 computes physical constraint compliance measures derived from stored metric and connection structures of the first latent manifold 110, including verification that the projected state preserves causal ordering relationships and does not violate encoded boundary conditions of the manifold 608. When the admissibility computation at step 608 indicates non-compliance with stored constraint tolerances, the flow proceeds to rejection at step 607.

When both the capacity computation at step 606 and the admissibility computation at step 608 indicate compliance with stored thresholds and constraint conditions, the projected visual state is incorporated into the first latent manifold 110, where it becomes an active state eligible for geodesic trajectory computation under the stored metric tensor and connection coefficients of the first latent manifold 110 609.

The predictive rollout and rendering subsystem 115 receives the incorporated projected visual state together with the translated uncertainty encodings produced at step 605 and subjects the state to Lorentzian geodesic rollout, generating probabilistic future state representations and producing synthetic visual output with opacity gradients, branching overlays, and perturbation envelopes reflecting the epistemic uncertainty of the originating cognitive state 610.

Upon completion of the outbound projection flow, whether resulting in rejection at step 603 or step 607 or in incorporation and rollout at step 610, the cross-manifold journaling subsystem 330 records the complete transfer event including source manifold coordinates, target manifold coordinates, transformation parameters, uncertainty translation parameters, computed capacity metrics, admissibility decision codes or defect identifiers, a timestamp, and a cryptographic hash linking the record to the preceding entry in a tamper-evident chain 611. Journaling occurs irrespective of outcome, thereby preserving traceability of both rejected and incorporated outbound projection attempts within defined reconstruction error tolerances.

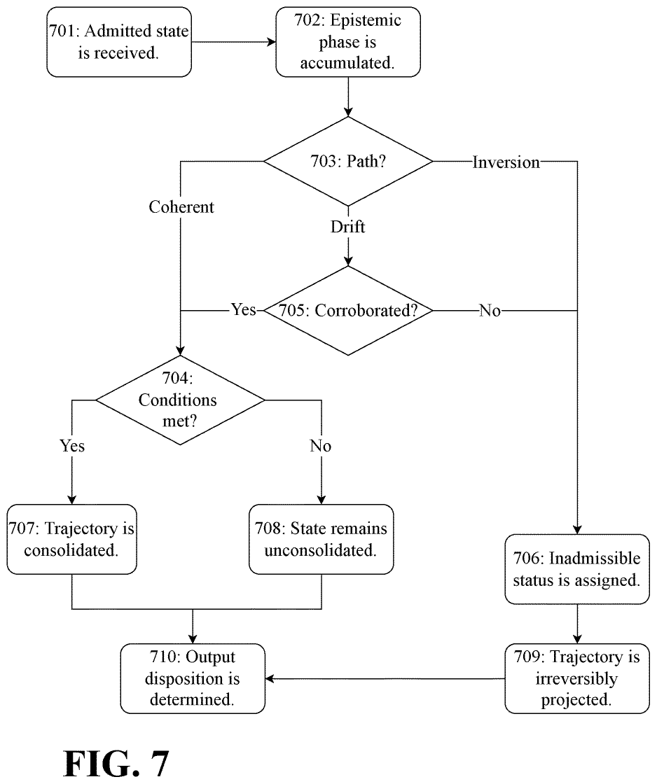

FIG. 7 is a flow diagram illustrating exemplary reasoning traversal and output flow within a second latent manifold 125 of a dual manifold PCM 100, in an embodiment. The flow begins when the reasoning traversal and output subsystem 130 receives an admitted cognitive state from the second latent manifold 125, where the admitted state may have been incorporated through the inbound projection component 305 of the bidirectional geometric interface operator 120 or may have originated from a prior reasoning traversal cycle 701.

The reasoning traversal and output subsystem 130 computes a reasoning trajectory as a sequence of edge transitions through the stored graph structure of the second latent manifold 125, accumulating epistemic phase along each edge by summing transition-specific phase values assigned by the epistemic connection associated with the manifold. During traversal, the subsystem concurrently computes local phase-consistency indicators, including detection of phase discontinuities and holonomy descriptor conflicts derived from discrete curvature values around partial loops, and may interrupt, redirect, backtrack, or suppress the active trajectory when computed discontinuity measures exceed stored tolerances 702.

Upon completion of a closed reasoning path, the reasoning traversal and output subsystem 130 computes the magnitude of accumulated epistemic phase and compares that magnitude to stored regime thresholds, classifying the path into a coherent regime when the accumulated phase magnitude does not exceed a first threshold, into a drift regime when the accumulated phase magnitude exceeds the first threshold but remains below a second threshold, or into an inversion regime when the accumulated phase magnitude meets or exceeds the second threshold 703. When the reasoning path is classified in the coherent regime, the flow proceeds to consolidation evaluation at step 704.

At step 704, the reasoning traversal and output subsystem 130 computes consolidation eligibility measures by evaluating whether the coherent reasoning path satisfies phase flatness conditions, determined by comparing epistemic curvature magnitude along a neighborhood of the path to a stored flatness threshold, and barrier energy conditions, determined by computing a boundary energy functional derived from curvature magnitude, extrinsic boundary curvature, and symplectic variation at the boundary of the candidate region.

When the reasoning path is classified in the drift regime at step 703, the reasoning traversal and output subsystem 130 evaluates whether the trajectory is corroborated by an independent path that is not deformable, under stored homotopy constraints of the reservoir-stratified state space of the second latent manifold 125, into the original trajectory 705. When corroboration is satisfied at step 705, the flow proceeds to consolidation evaluation at step 704. When corroboration is not satisfied, the reasoning traversal and output subsystem 130 assigns an epistemically inadmissible status flag to the trajectory 706. When the reasoning path is classified in the inversion regime at step 703, the reasoning traversal and output subsystem 130 assigns an epistemically inadmissible status flag at step 706 without performing corroboration evaluation.

When the phase flatness and barrier energy conditions are satisfied at step 704, the reasoning traversal and output subsystem 130 commits the reasoning path and its associated cognitive states to a consolidated reservoir 216 within the second latent manifold 125 by storing the corresponding region as a non-modifiable subgraph accessible during subsequent reasoning traversal and admissibility evaluation 707. When the phase flatness and barrier energy conditions are not satisfied at step 704, the reasoning traversal and output subsystem 130 retains the cognitive states associated with the reasoning path as admissible but unconsolidated states within the second latent manifold 125, where such states remain eligible for participation in future reasoning traversal and may be subsequently consolidated if the consolidation conditions are later satisfied 708.

When a trajectory has been assigned an epistemically inadmissible status at step 706, the reasoning traversal and output subsystem 130 applies a non-invertible transformation that projects the trajectory into an irreversible constraint reservoir, removing navigable transitions associated with the trajectory while preserving canonical identifiers sufficient to detect structurally similar inadmissible patterns in future reasoning cycles 709.

Upon convergence of the terminal paths of steps 707, 708, and 709, the reasoning traversal and output subsystem 130 determines output disposition based on the epistemic admissibility status of the completed trajectory, generating output from trajectories that remain epistemically admissible, qualifying output with reduced confidence when admissibility margins approach stored thresholds, or suppressing output when no admissible trajectory supports a response 710. In this manner, reasoning output is conditioned on geometric and phase-coherence constraints encoded within the second latent manifold 125, thereby constraining the expansion of the cognitive state space to regions satisfying stored admissibility and capacity criteria.

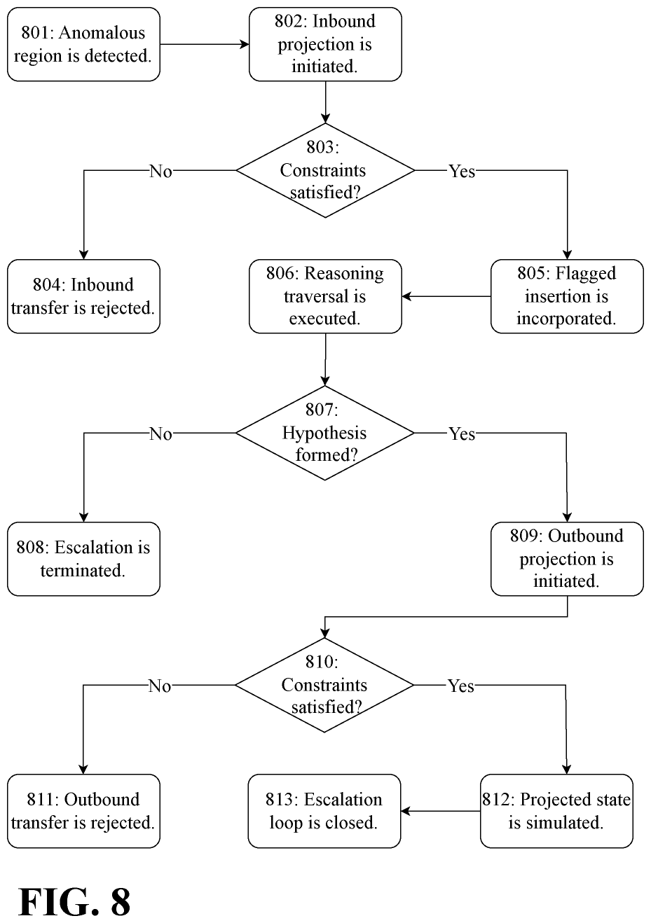

FIG. 8 is a flow diagram illustrating exemplary bidirectional anomaly escalation loop of a dual manifold PCM 100, in an embodiment. The flow begins when the predictive rollout and rendering subsystem 115 detects a region of the first latent manifold 110 exhibiting anomalous characteristics, such as curvature magnitude exceeding a stored threshold, rapidly expanding uncertainty cone geometry exceeding a stored variance tolerance, or proximity to compression-pressure constraint boundaries identified during forward geodesic trajectory computation 801.

The bidirectional geometric interface operator 120 receives the anomalous state and initiates the inbound projection flow, wherein the inbound projection component 305 computes a provisional cognitive embedding through structural reconciliation, the cross-manifold uncertainty translation subsystem 325 transforms Lorentzian uncertainty parameters into epistemic confidence attenuation measures, and the provisional embedding is forwarded to the interface capacity mediator 315 and the interface admissibility evaluator 320 for computation of capacity and admissibility measures derived from geometric properties of the second latent manifold 125 802.

At step 803, the interface capacity mediator 315 computes projected structural density relative to local symplectic capacity and the interface admissibility evaluator 320 computes compatibility residuals, phase-consistency measures, and boundary conflict indicators associated with the provisional embedding. These computed measures are compared to stored interface thresholds. When either the capacity measures or admissibility measures fall outside defined tolerances, the bidirectional geometric interface operator 120 rejects the inbound transfer and the cross-manifold journaling subsystem 330 records the rejection event including diagnostic codes identifying the constraint condition that prevented incorporation 804.

When both inbound capacity and admissibility measures satisfy stored thresholds, the projected state is incorporated into the second latent manifold 125 as a flagged cognitive insertion with reduced commitment pending corroboration, thereby enabling structured reasoning while maintaining bounded commitment status 805.

The reasoning traversal and output subsystem 130 receives the flagged insertion from the second latent manifold 125 and computes candidate reasoning trajectories by accumulating epistemic phase along paths connecting the anomalous insertion to neighboring cognitive states and to regions of consolidated knowledge stored in the consolidated reservoir 216. During traversal, evidential consistency is assessed using accumulated phase magnitude and curvature-derived measures as defined in the reasoning traversal flow 806.

At step 807, the reasoning traversal and output subsystem 130 determines whether traversal has yielded a cognitive state that satisfies admissibility and coherence criteria sufficient to constitute a structured hypothesis regarding the detected anomaly.

When no such admissible hypothesis is produced at step 807, the reasoning traversal and output subsystem 130 retains the cognitive state as admissible but unconsolidated or suppresses the state if marked inadmissible, and the escalation loop terminates without outbound projection 808.

When a structured and epistemically admissible hypothesis is produced at step 807, the hypothesis is forwarded to the bidirectional geometric interface operator 120, which initiates the outbound projection flow. The outbound projection component 310 computes epistemic eligibility indicators, applies structural reconciliation using geodesic map functions relative to the first latent manifold 110, and the cross-manifold uncertainty translation subsystem 325 transforms epistemic uncertainty measures into visual uncertainty encodings. The projected visual state is forwarded to the interface capacity mediator 315 and the interface admissibility evaluator 320 for outbound constraint computation 809.

At step 810, the interface capacity mediator 315 computes deformation energy and verifies compliance with compression-pressure thresholds encoded in the first latent manifold 110, and the interface admissibility evaluator 320 computes physical constraint compliance measures derived from stored metric and connection structures of the first latent manifold 110. When any outbound eligibility, capacity, or admissibility measure falls outside stored tolerances, the bidirectional geometric interface operator 120 rejects the outbound transfer and the cross-manifold journaling subsystem 330 records the rejection event including diagnostic codes identifying the constraint condition 811.

When all outbound eligibility, capacity, and admissibility measures satisfy stored thresholds, the projected visual state is incorporated into the first latent manifold 110. The predictive rollout and rendering subsystem 115 subjects the incorporated state to Lorentzian geodesic rollout under stored metric and connection coefficients, generating probabilistic future state representations and producing synthetic visual output with opacity gradients, branching overlays, and perturbation envelopes reflecting the epistemic confidence of the originating cognitive hypothesis 812.

The states resulting from the predictive rollout at step 812 are encoded within the first latent manifold 110 as active states eligible for subsequent anomaly detection and selection as candidates for further inbound projection through the bidirectional geometric interface operator 120. In this manner, perception-driven anomaly detection, epistemically conditioned reasoning, and physically constrained simulation operate within a closed-loop architecture in which cross-manifold transfers are mediated by capacity and admissibility computations at each direction of transfer, thereby maintaining bounded and geometrically regulated interaction between the manifolds 813.

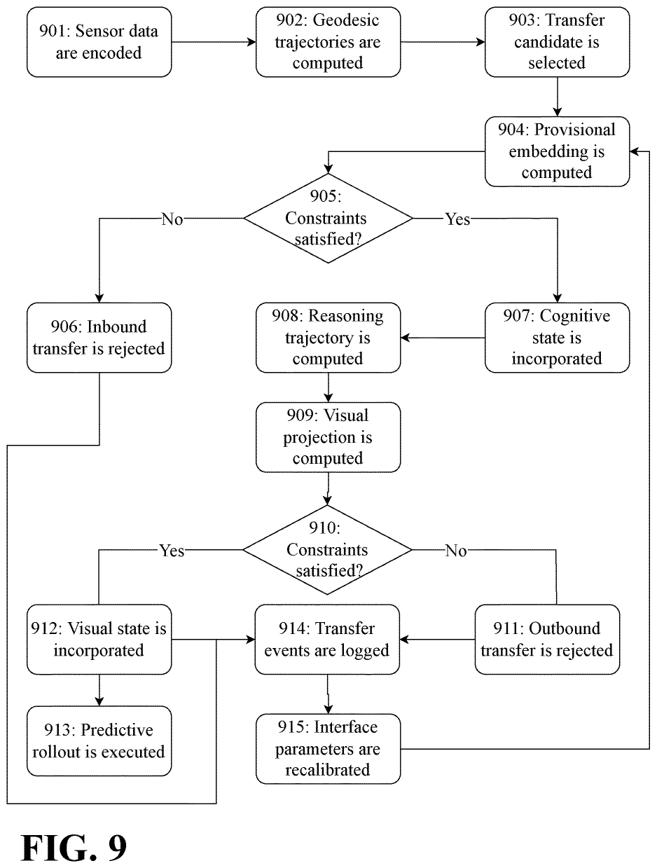

FIG. 9 is a flow diagram illustrating exemplary end-to-end operational data flow of a dual manifold PCM 100, in an embodiment. The flow begins when the telemetry and perceptual ingestion subsystem 105 receives external sensor and telemetry inputs 101, applies modality-specific signal conditioning, encodes the conditioned data into structured latent tensor representations with associated uncertainty parameters, and writes the resulting encoded states into the first latent manifold 110 as vertices within a stored graph structure endowed with metric and connection data 901.

The predictive rollout and rendering subsystem 115 retrieves states from the first latent manifold 110 and computes forward geodesic trajectories under a stored pseudo-Riemannian metric tensor and associated connection coefficients, generating predicted future states together with associated uncertainty cone representations derived from covariance or perturbation parameters 902. A candidate state is selected from the first latent manifold 110 for cross-manifold transfer, where the candidate state may correspond to a current perceptual embedding, a predicted future state generated through geodesic rollout, a region exhibiting uncertainty magnitude exceeding a stored threshold, or a state flagged as anomalous based on curvature magnitude or compression-pressure proximity conditions detected during predictive rollout 903.

The inbound projection component 305 of the bidirectional geometric interface operator 120 receives the candidate state and computes a provisional cognitive embedding through structural reconciliation operations that map the Lorentzian tensor representation into coordinates compatible with a semantic metric of the second latent manifold 125, normalize scale differences between metric structures, and preserve temporal ordering derived from causal structure of the first latent manifold 110. In coordination with these reconciliation operations, the cross-manifold uncertainty translation subsystem 325 transforms Lorentzian uncertainty structures, including covariance matrices or uncertainty cone parameters, into epistemic confidence attenuation or phase variance values compatible with epistemic conditioning of the second latent manifold 125, preserving monotonic relationships between source and target uncertainty magnitudes 904.

The provisional cognitive embedding and associated translated uncertainty parameters are forwarded to the interface capacity mediator 315 and the interface admissibility evaluator 320. The interface capacity mediator 315 computes a projected post-insertion structural density relative to local symplectic capacity in a neighborhood of a provisional insertion location in the second latent manifold 125 and compares the computed density to stored interface capacity thresholds retrieved from hardware memory. The interface admissibility evaluator 320 computes structural compatibility residuals by comparing interpolated almost-complex structure values at the provisional insertion location against neighboring values, performs phase-consistency screening over bounded closed paths to detect local epistemic inconsistency, and evaluates conflicts with admissibility boundaries or consolidated reservoir boundaries encoded in the second latent manifold 125. The computed residuals and phase measures are compared to stored admissibility tolerances maintained in hardware memory 905.

When the capacity residuals or admissibility residuals fall outside defined tolerances at step 905, the bidirectional geometric interface operator 120 rejects the inbound transfer, refrains from modifying the second latent manifold 125, and forwards diagnostic codes identifying the specific constraint condition to the cross-manifold journaling subsystem 330, which records the rejection event in non-volatile memory as part of a cryptographically chained log 906. When both inbound capacity and admissibility measures satisfy stored thresholds at step 905, the projected cognitive state is incorporated into the second latent manifold 125 with an assigned outcome code comprising, for example, absorb or flag status, and the cross-manifold journaling subsystem 330 records the complete inbound transfer event including source coordinates, projected coordinates, transformation parameters, translated uncertainty parameters, computed capacity metrics, and decision codes 907.

The reasoning traversal and output subsystem 130 receives the incorporated state from the second latent manifold 125 and computes reasoning trajectories by traversing stored edge structures while accumulating epistemic phase values assigned by an epistemic connection. Completed reasoning paths are classified into coherent, drift, or inversion regimes based on accumulated phase magnitude relative to stored regime thresholds, and output is generated, qualified, or suppressed based on admissibility status and phase-coherence conditions encoded in the second latent manifold 125 908. A cognitive state produced by the reasoning traversal and output subsystem 130 that satisfies epistemic eligibility criteria is forwarded to the outbound projection component 310 of the bidirectional geometric interface operator 120.

The outbound projection component 310 verifies that the candidate cognitive state is not marked epistemically inadmissible and does not belong to a suppressed trajectory class, and computes a projected visual state using exponential or logarithmic map functions relative to local geodesic structure of the first latent manifold 110 while preserving causal ordering and temporal coherence constraints. In coordination with projection, the cross-manifold uncertainty translation subsystem 325 transforms epistemic phase variance or confidence attenuation values into visual uncertainty encodings including opacity gradients, branching trajectory overlays, or probabilistic perturbation envelopes suitable for predictive rollout within the first latent manifold 110 909.

The projected visual state and associated uncertainty encodings are forwarded to the interface capacity mediator 315 and the interface admissibility evaluator 320. The interface capacity mediator 315 computes deformation energy induced by embedding the projected state into the first latent manifold 110 and compares the computed deformation energy to stored compression-pressure threshold parameters, thereby evaluating whether incorporation would exceed permissible structural deformation bounds. The interface admissibility evaluator 320 computes physical constraint residuals derived from stored metric and connection structures of the first latent manifold 110, including verification that the projected state preserves causal ordering relationships and does not violate encoded boundary conditions of the manifold 910.

When any outbound eligibility, deformation, or constraint residual exceeds stored tolerances at step 910, the bidirectional geometric interface operator 120 rejects the outbound transfer, refrains from modifying the first latent manifold 110, and forwards diagnostic codes to the cross-manifold journaling subsystem 330, which records the rejection event in the cryptographically chained transfer log 911. When all outbound eligibility, deformation, and constraint residuals satisfy stored thresholds at step 910, the projected visual state is incorporated into the first latent manifold 110 as an active vertex within its stored graph structure, and the cross-manifold journaling subsystem 330 records the complete outbound transfer event including transformation parameters, deformation metrics, uncertainty translation parameters, and decision codes 912.

The predictive rollout and rendering subsystem 115 receives the incorporated projected visual state together with translated uncertainty encodings and subjects the state to Lorentzian geodesic rollout under stored metric and connection coefficients, generating probabilistic future state representations and producing synthetic visual output with opacity gradients, branching overlays, and perturbation envelopes reflecting epistemic confidence of the originating cognitive state 913.

Transfer event records from inbound incorporation at step 907, inbound rejection at step 906, outbound incorporation at step 912, and outbound rejection at step 911 are accumulated in the cross-manifold journaling subsystem 330 as a persistent, cryptographically chained record of cross-manifold transfer activity stored in non-volatile memory, enabling reconstruction of projected states to corresponding source states within bounded reconstruction error tolerances 914.

The adaptive interface recalibration subsystem 335 periodically retrieves accumulated historical transfer records from the cross-manifold journaling subsystem 330 and computes aggregate performance metrics, including approval-to-rejection ratios, reconstruction error magnitudes, frequency of capacity threshold exceedance, deformation energy margin utilization, and manifold growth indicators derived from current geometric properties of the first latent manifold 110 and the second latent manifold 125. Based on these computed metrics, the adaptive interface recalibration subsystem 335 updates stored interface capacity thresholds, projection norms, and structural compatibility mappings used by the inbound projection component 305, the outbound projection component 310, the interface capacity mediator 315, and the interface admissibility evaluator 320. Updated parameters are written to hardware memory and become active in subsequent transfer cycles, as indicated by a feedback path from step 915 to step 904, thereby adaptively regulating the reachable computational state space of the PCM 100 while preserving geometric separation between the first latent manifold 110 and the second latent manifold 125 915.

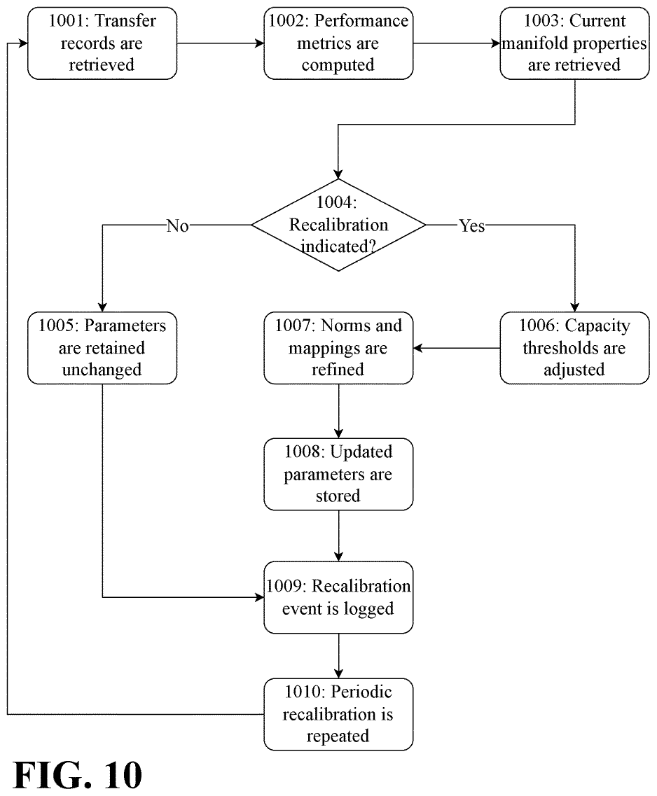

FIG. 10 is a flow diagram illustrating exemplary adaptive recalibration process flow of a dual manifold PCM 100, in an embodiment. The flow begins when the adaptive interface recalibration subsystem 335 retrieves accumulated historical transfer records from the cross-manifold journaling subsystem 330, where the retrieved records include inbound and outbound transfer events, rejection events, source and target manifold coordinates, transformation parameters, capacity and admissibility decision codes, uncertainty translation parameters, and cryptographic hash linkages stored in non-volatile memory 1001.

The adaptive interface recalibration subsystem 335 computes aggregate performance metrics from the retrieved transfer records, including approval-to-rejection ratios for inbound and outbound transfers, reconstruction error magnitudes derived from stored inverse mapping parameters, frequency of capacity threshold exceedance events, deformation energy margin utilization for outbound projections, and distributions of admissibility outcome codes across recent transfer cycles 1002.

The adaptive interface recalibration subsystem 335 retrieves current geometric properties of the first latent manifold 110 and the second latent manifold 125, including current manifold size indicators derived from vertex and edge counts of respective stored graph structures, local density distributions, symplectic capacity measures over representative neighborhoods of the second latent manifold 125, and compression-pressure constraint parameters encoded in the first latent manifold 110 1003.

The adaptive interface recalibration subsystem 335 evaluates the computed aggregate performance metrics against the retrieved current geometric properties to determine whether stored interface parameters remain well-calibrated relative to the present state of both manifolds, comparing historical projection performance to current manifold density, capacity utilization, and structural deformation characteristics 1004.

When the evaluation at step 1004 indicates that computed performance metrics fall within defined stability tolerances relative to current manifold geometry, the adaptive interface recalibration subsystem 335 determines that recalibration is not indicated and retains current interface parameters without modification, preserving existing capacity thresholds, projection norms, and structural compatibility mappings in hardware memory 1005.

When the evaluation at step 1004 indicates that one or more computed performance metrics deviate from defined stability tolerances relative to current manifold geometry, the adaptive interface recalibration subsystem 335 computes updated capacity thresholds by adjusting stored interface capacity density thresholds for inbound transfers relative to current symplectic capacity measures of the second latent manifold 125 and adjusting stored compression-pressure and deformation energy thresholds for outbound transfers relative to current metric properties of the first latent manifold 110 1006.

The adaptive interface recalibration subsystem 335 computes updated projection norms by refining scale normalization parameters and metric reconciliation coefficients used by the inbound projection component 305 and the outbound projection component 310 to reduce structural reconciliation error observed in historical transfer records, and computes updated structural compatibility mappings by adjusting compatibility residual tolerances and phase-consistency screening parameters used by the interface admissibility evaluator 320 to reflect evolved geometric relationships between the first latent manifold 110 and the second latent manifold 125 1007.

The adaptive interface recalibration subsystem 335 writes the updated capacity thresholds, projection norms, and structural compatibility mappings to hardware memory locations accessible by the inbound projection component 305, the outbound projection component 310, the interface capacity mediator 315, and the interface admissibility evaluator 320 of the bidirectional geometric interface operator 120, with the updated parameters becoming active in subsequent cross-manifold transfer cycles 1008.

The cross-manifold journaling subsystem 330 records the recalibration event as a distinct event class in the cryptographically chained transfer log, including identifiers of the parameters modified or retained, prior parameter values, updated parameter values where applicable, the aggregate performance metrics that informed the recalibration determination, and a timestamp and cryptographic hash linking the recalibration record to the preceding log entry 1009. The adaptive recalibration process operates periodically on a background timescale distinct from real-time transfer events, with each completed cycle producing an updated journaling record that becomes part of the historical record available for evaluation in subsequent recalibration cycles 1010.

### Exemplary Computing Environment

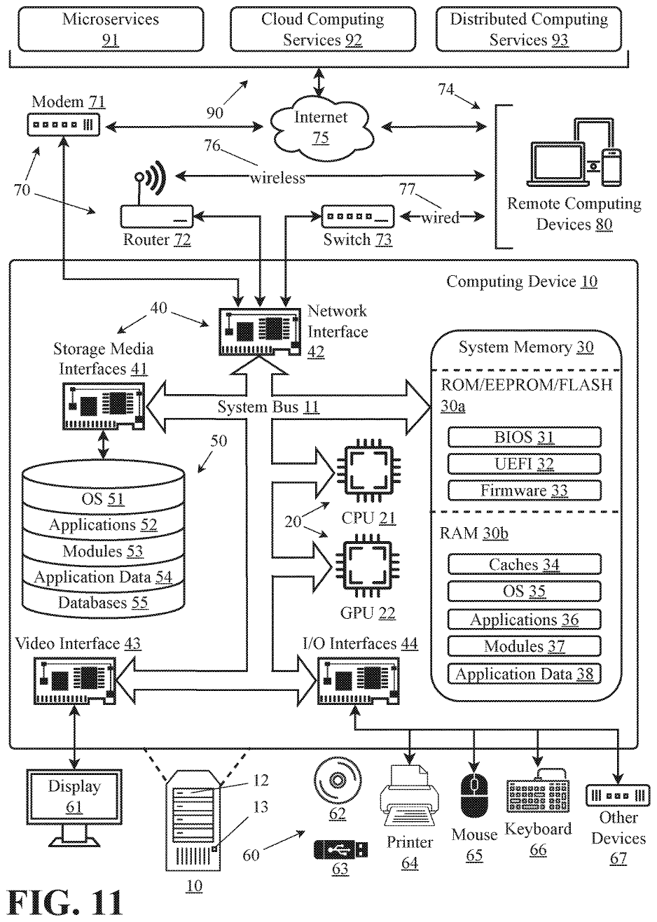

FIG. 11 illustrates an exemplary computing environment on which an embodiment described herein may be implemented, in full or in part. This exemplary computing environment describes computer-related components and processes supporting enabling disclosure of computer-implemented embodiments. Inclusion in this exemplary computing environment of well-known processes and computer components, if any, is not a suggestion or admission that any embodiment is no more than an aggregation of such processes or components. Rather, implementation of an embodiment using processes and components described in this exemplary computing environment will involve programming or configuration of such processes and components resulting in a machine specially programmed or configured for such implementation. The exemplary computing environment described herein is only one example of such an environment and other configurations of the components and processes are possible, including other relationships between and among components, and/or absence of some processes or components described. Further, the exemplary computing environment described herein is not intended to suggest any limitation as to the scope of use or functionality of any embodiment implemented, in whole or in part, on components or processes described herein.

The exemplary computing environment described herein comprises a computing device 10 (further comprising a system bus 11, one or more processors 20, a system memory 30, one or more interfaces 40, one or more non-volatile data storage devices 50), external peripherals and accessories 60, external communication devices 70, remote computing devices 80, and cloud-based services 90.

System bus 11 couples the various system components, coordinating operation of and data transmission between those various system components. System bus 11 represents one or more of any type or combination of types of wired or wireless bus structures including, but not limited to, memory busses or memory controllers, point-to-point connections, switching fabrics, peripheral busses, accelerated graphics ports, and local busses using any of a variety of bus architectures. By way of example, such architectures include, but are not limited to, Industry Standard Architecture (ISA) busses, Micro Channel Architecture (MCA) busses, Enhanced ISA (EISA) busses, Video Electronics Standards Association (VESA) local busses, a Peripheral Component Interconnects (PCI) busses also known as a Mezzanine busses, or any selection of, or combination of, such busses. Depending on the specific physical implementation, one or more of the processors 20, system memory 30 and other components of the computing device 10 can be physically co-located or integrated into a single physical component, such as on a single chip. In such a case, some or all of system bus 11 can be electrical pathways within a single chip structure.

Computing device may further comprise externally-accessible data input and storage devices 12 such as compact disc read-only memory (CD-ROM) drives, digital versatile discs (DVD), or other optical disc storage for reading and/or writing optical discs 62; magnetic cassettes, magnetic tape, magnetic disk storage, or other magnetic storage devices; or any other medium which can be used to store the desired content and which can be accessed by the computing device 10. Computing device may further comprise externally-accessible data ports or connections 12 such as serial ports, parallel ports, universal serial bus (USB) ports, and infrared ports and/or transmitter/receivers. Computing device may further comprise hardware for wireless communication with external devices such as IEEE 1394 (“Firewire”) interfaces, IEEE 802.11 wireless interfaces, BLUETOOTH® wireless interfaces, and so forth. Such ports and interfaces may be used to connect any number of external peripherals and accessories 60 such as visual displays, monitors, and touch-sensitive screens 61, USB solid state memory data storage drives (commonly known as “flash drives” or “thumb drives”) 63, printers 64, pointers and manipulators such as mice 65, keyboards 66, and other devices 67 such as joysticks and gaming pads, touchpads, additional displays and monitors, and external hard drives (whether solid state or disc-based), microphones, speakers, cameras, and optical scanners.

Processors 20 are logic circuitry capable of receiving programming instructions and processing (or executing) those instructions to perform computer operations such as retrieving data, storing data, and performing mathematical calculations. Processors 20 are not limited by the materials from which they are formed or the processing mechanisms employed therein, but are typically comprised of semiconductor materials into which many transistors are formed together into logic gates on a chip (i.e., an integrated circuit or IC). The term processor includes any device capable of receiving and processing instructions including, but not limited to, processors operating on the basis of quantum computing, optical computing, mechanical computing (e.g., using nanotechnology entities to transfer data), and so forth. Depending on configuration, computing device 10 may comprise more than one processor. For example, computing device 10 may comprise one or more central processing units (CPUs) 21, each of which itself has multiple processors or multiple processing cores, each capable of independently or semi-independently processing programming instructions based on technologies like complex instruction set computer (CISC) or reduced instruction set computer (RISC). Further, computing device 10 may comprise one or more specialized processors such as a graphics processing unit (GPU) 22 configured to accelerate processing of computer graphics and images via a large array of specialized processing cores arranged in parallel. Further computing device 10 may be comprised of one or more specialized processes such as Intelligent Processing Units, field-programmable gate arrays or application-specific integrated circuits for specific tasks or types of tasks. The term processor may further include: neural processing units (NPUs) or neural computing units optimized for machine learning and artificial intelligence workloads using specialized architectures and data paths; tensor processing units (TPUs) designed to efficiently perform matrix multiplication and convolution operations used heavily in neural networks and deep learning applications; application-specific integrated circuits (ASICs) implementing custom logic for domain-specific tasks; application-specific instruction set processors (ASIPs) with instruction sets tailored for particular applications; field-programmable gate arrays (FPGAs) providing reconfigurable logic fabric that can be customized for specific processing tasks; processors operating on emerging computing paradigms such as quantum computing, optical computing, mechanical computing (e.g., using nanotechnology entities to transfer data), and so forth. Depending on configuration, computing device 10 may comprise one or more of any of the above types of processors in order to efficiently handle a variety of general purpose and specialized computing tasks. The specific processor configuration may be selected based on performance, power, cost, or other design constraints relevant to the intended application of computing device 10.

System memory 30 is processor-accessible data storage in the form of volatile and/or nonvolatile memory. System memory 30 may be either or both of two types: non-volatile memory and volatile memory. Non-volatile memory 30a is not erased when power to the memory is removed, and includes memory types such as read only memory (ROM), electronically-erasable programmable memory (EEPROM), and rewritable solid state memory (commonly known as “flash memory”). Non-volatile memory 30a is typically used for long-term storage of a basic input/output system (BIOS) 31, containing the basic instructions, typically loaded during computer startup, for transfer of information between components within computing device, or a unified extensible firmware interface (UEFI), which is a modern replacement for BIOS that supports larger hard drives, faster boot times, more security features, and provides native support for graphics and mouse cursors. Non-volatile memory 30a may also be used to store firmware comprising a complete operating system 35 and applications 36 for operating computer-controlled devices. The firmware approach is often used for purpose-specific computer-controlled devices such as appliances and Internet-of-Things (IoT) devices where processing power and data storage space is limited. Volatile memory 30b is erased when power to the memory is removed and is typically used for short-term storage of data for processing. Volatile memory 30b includes memory types such as random-access memory (RAM), and is normally the primary operating memory into which the operating system 35, applications 36, program modules 37, and application data 38 are loaded for execution by processors 20. Volatile memory 30b is generally faster than non-volatile memory 30a due to its electrical characteristics and is directly accessible to processors 20 for processing of instructions and data storage and retrieval. Volatile memory 30b may comprise one or more smaller cache memories which operate at a higher clock speed and are typically placed on the same IC as the processors to improve performance.

There are several types of computer memory, each with its own characteristics and use cases. System memory 30 may be configured in one or more of the several types described herein, including high bandwidth memory (HBM) and advanced packaging technologies like chip-on-wafer-on-substrate (CoWoS). Static random access memory (SRAM) provides fast, low-latency memory used for cache memory in processors, but is more expensive and consumes more power compared to dynamic random access memory (DRAM). SRAM retains data as long as power is supplied. DRAM is the main memory in most computer systems and is slower than SRAM but cheaper and more dense. DRAM requires periodic refresh to retain data. NAND flash is a type of non-volatile memory used for storage in solid state drives (SSDs) and mobile devices and provides high density and lower cost per bit compared to DRAM with the trade-off of slower write speeds and limited write endurance. HBM is an emerging memory technology that provides high bandwidth and low power consumption which stacks multiple DRAM dies vertically, connected by through-silicon vias (TSVs). HBM offers much higher bandwidth (up to 1 TB/s) compared to traditional DRAM and may be used in high-performance graphics cards, AI accelerators, and edge computing devices. Advanced packaging and CoWoS are technologies that enable the integration of multiple chips or dies into a single package. CoWoS is a 2.5D packaging technology that interconnects multiple dies side-by-side on a silicon interposer and allows for higher bandwidth, lower latency, and reduced power consumption compared to traditional PCB-based packaging. This technology enables the integration of heterogeneous dies (e.g., CPU, GPU, HBM) in a single package and may be used in high-performance computing, AI accelerators, and edge computing devices.

Interfaces 40 may include, but are not limited to, storage media interfaces 41, network interfaces 42, display interfaces 43, and input/output interfaces 44. Storage media interface 41 provides the necessary hardware interface for loading data from non-volatile data storage devices 50 into system memory 30 and storage data from system memory 30 to non-volatile data storage device 50. Network interface 42 provides the necessary hardware interface for computing device 10 to communicate with remote computing devices 80 and cloud-based services 90 via one or more external communication devices 70. Display interface 43 allows for connection of displays 61, monitors, touchscreens, and other visual input/output devices. Display interface 43 may include a graphics card for processing graphics-intensive calculations and for handling demanding display requirements. Typically, a graphics card includes a graphics processing unit (GPU) and video RAM (VRAM) to accelerate display of graphics. In some high-performance computing systems, multiple GPUs may be connected using NVLink bridges, which provide high-bandwidth, low-latency interconnects between GPUs. NVLink bridges enable faster data transfer between GPUs, allowing for more efficient parallel processing and improved performance in applications such as machine learning, scientific simulations, and graphics rendering. One or more input/output (I/O) interfaces 44 provide the necessary support for communications between computing device 10 and any external peripherals and accessories 60. For wireless communications, the necessary radio-frequency hardware and firmware may be connected to I/O interface 44 or may be integrated into I/O interface 44. Network interface 42 may support various communication standards and protocols, such as Ethernet and Small Form-Factor Pluggable (SFP). Ethernet is a widely used wired networking technology that enables local area network (LAN) communication. Ethernet interfaces typically use RJ45 connectors and support data rates ranging from 10 Mbps to 100 Gbps, with common speeds being 100 Mbps, 1 Gbps, 10 Gbps, 25 Gbps, 40 Gbps, and 100 Gbps. Ethernet is known for its reliability, low latency, and cost-effectiveness, making it a popular choice for home, office, and data center networks. SFP is a compact, hot-pluggable transceiver used for both telecommunication and data communications applications. SFP interfaces provide a modular and flexible solution for connecting network devices, such as switches and routers, to fiber optic or copper networking cables. SFP transceivers support various data rates, ranging from 100 Mbps to 100 Gbps, and can be easily replaced or upgraded without the need to replace the entire network interface card. This modularity allows for network scalability and adaptability to different network requirements and fiber types, such as single-mode or multi-mode fiber.

Non-volatile data storage devices 50 are typically used for long-term storage of data. Data on non-volatile data storage devices 50 is not erased when power to the non-volatile data storage devices 50 is removed. Non-volatile data storage devices 50 may be implemented using any technology for non-volatile storage of content including, but not limited to, CD-ROM drives, digital versatile discs (DVD), or other optical disc storage; magnetic cassettes, magnetic tape, magnetic disc storage, or other magnetic storage devices; solid state memory technologies such as EEPROM or flash memory; or other memory technology or any other medium which can be used to store data without requiring power to retain the data after it is written. Non-volatile data storage devices 50 may be non-removable from computing device 10 as in the case of internal hard drives, removable from computing device 10 as in the case of external USB hard drives, or a combination thereof, but computing device will typically comprise one or more internal, non-removable hard drives using either magnetic disc or solid state memory technology. Non-volatile data storage devices 50 may be implemented using various technologies, including hard disk drives (HDDs) and solid-state drives (SSDs). HDDs use spinning magnetic platters and read/write heads to store and retrieve data, while SSDs use NAND flash memory. SSDs offer faster read/write speeds, lower latency, and better durability due to the lack of moving parts, while HDDs typically provide higher storage capacities and lower cost per gigabyte. NAND flash memory comes in different types, such as Single-Level Cell (SLC), Multi-Level Cell (MLC), Triple-Level Cell (TLC), and Quad-Level Cell (QLC), each with trade-offs between performance, endurance, and cost. Storage devices connect to the computing device 10 through various interfaces, such as SATA, NVMe, and PCIe. SATA is the traditional interface for HDDs and SATA SSDs, while NVMe (Non-Volatile Memory Express) is a newer, high-performance protocol designed for SSDs connected via PCIe. PCIe SSDs offer the highest performance due to the direct connection to the PCIe bus, bypassing the limitations of the SATA interface. Other storage form factors include M.2 SSDs, which are compact storage devices that connect directly to the motherboard using the M.2 slot, supporting both SATA and NVMe interfaces. Additionally, technologies like Intel Optane memory combine 3D XPoint technology with NAND flash to provide high-performance storage and caching solutions. Non-volatile data storage devices 50 may be non-removable from computing device 10, as in the case of internal hard drives, removable from computing device 10, as in the case of external USB hard drives, or a combination thereof. However, computing devices will typically comprise one or more internal, non-removable hard drives using either magnetic disc or solid-state memory technology. Non-volatile data storage devices 50 may store any type of data including, but not limited to, an operating system 51 for providing low-level and mid-level functionality of computing device 10, applications 52 for providing high-level functionality of computing device 10, program modules 53 such as containerized programs or applications, or other modular content or modular programming, application data 54, and databases 55 such as relational databases, non-relational databases, object oriented databases, NoSQL databases, vector databases, knowledge graph databases, key-value databases, document oriented data stores, and graph databases.

Applications (also known as computer software or software applications) are sets of programming instructions designed to perform specific tasks or provide specific functionality on a computer or other computing devices. Applications are typically written in high-level programming languages such as C, C++, Scala, Erlang, GoLang, Java, Scala, Rust, and Python, which are then either interpreted at runtime or compiled into low-level, binary, processor-executable instructions operable on processors 20. Applications may be containerized so that they can be run on any computer hardware running any known operating system. Containerization of computer software is a method of packaging and deploying applications along with their operating system dependencies into self-contained, isolated units known as containers. Containers provide a lightweight and consistent runtime environment that allows applications to run reliably across different computing environments, such as development, testing, and production systems facilitated by specifications such as containerd.

The memories and non-volatile data storage devices described herein do not include communication media. Communication media are means of transmission of information such as modulated electromagnetic waves or modulated data signals configured to transmit, not store, information. By way of example, and not limitation, communication media includes wired communications such as sound signals transmitted to a speaker via a speaker wire, and wireless communications such as acoustic waves, radio frequency (RF) transmissions, infrared emissions, and other wireless media.

External communication devices 70 are devices that facilitate communications between computing device and either remote computing devices 80, or cloud-based services 90, or both. External communication devices 70 include, but are not limited to, data modems 71 which facilitate data transmission between computing device and the Internet 75 via a common carrier such as a telephone company or internet service provider (ISP), routers 72 which facilitate data transmission between computing device and other devices, and switches 73 which provide direct data communications between devices on a network or optical transmitters (e.g., lasers). Here, modem 71 is shown connecting computing device 10 to both remote computing devices 80 and cloud-based services 90 via the Internet 75. While modem 71, router 72, and switch 73 are shown here as being connected to network interface 42, many different network configurations using external communication devices 70 are possible. Using external communication devices 70, networks may be configured as local area networks (LANs) for a single location, building, or campus, wide area networks (WANs) comprising data networks that extend over a larger geographical area, and virtual private networks (VPNs) which can be of any size but connect computers via encrypted communications over public networks such as the Internet 75. As just one exemplary network configuration, network interface 42 may be connected to switch 73 which is connected to router 72 which is connected to modem 71 which provides access for computing device 10 to the Internet 75. Further, any combination of wired 77 or wireless 76 communications between and among computing device 10, external communication devices 70, remote computing devices 80, and cloud-based services 90 may be used. Remote computing devices 80, for example, may communicate with computing device through a variety of communication channels 74 such as through switch 73 via a wired 77 connection, through router 72 via a wireless connection 76, or through modem 71 via the Internet 75. Furthermore, while not shown here, other hardware that is specifically designed for servers or networking functions may be employed. For example, secure socket layer (SSL) acceleration cards can be used to offload SSL encryption computations, and transmission control protocol/internet protocol (TCP/IP) offload hardware and/or packet classifiers on network interfaces 42 may be installed and used at server devices or intermediate networking equipment (e.g., for deep packet inspection).

In a networked environment, certain components of computing device 10 may be fully or partially implemented on remote computing devices 80 or cloud-based services 90. Data stored in non-volatile data storage device 50 may be received from, shared with, duplicated on, or offloaded to a non-volatile data storage device on one or more remote computing devices 80 or in a cloud computing service 92. Processing by processors 20 may be received from, shared with, duplicated on, or offloaded to processors of one or more remote computing devices 80 or in a distributed computing service 93. By way of example, data may reside on a cloud computing service 92, but may be usable or otherwise accessible for use by computing device 10. Also, certain processing subtasks may be sent to a microservice 91 for processing with the result being transmitted to computing device 10 for incorporation into a larger processing task. Also, while components and processes of the exemplary computing environment are illustrated herein as discrete units (e.g., OS 51 being stored on non-volatile data storage device 51 and loaded into system memory 35 for use) such processes and components may reside or be processed at various times in different components of computing device 10, remote computing devices 80, and/or cloud-based services 90. Also, certain processing subtasks may be sent to a microservice 91 for processing with the result being transmitted to computing device 10 for incorporation into a larger processing task. Infrastructure as Code (IaaC) tools like Terraform can be used to manage and provision computing resources across multiple cloud providers or hyperscalers. This allows for workload balancing based on factors such as cost, performance, and availability. For example, Terraform can be used to automatically provision and scale resources on AWS spot instances during periods of high demand, such as for surge rendering tasks, to take advantage of lower costs while maintaining the required performance levels. In the context of rendering, tools like Blender can be used for object rendering of specific elements, such as a car, bike, or house. These elements can be approximated and roughed in using techniques like bounding box approximation or low-poly modeling to reduce the computational resources required for initial rendering passes. The rendered elements can then be integrated into the larger scene or environment as needed, with the option to replace the approximated elements with higher-fidelity models as the rendering process progresses.

In an implementation, the disclosed systems and methods may utilize, at least in part, containerization techniques to execute one or more processes and/or steps disclosed herein. Containerization is a lightweight and efficient virtualization technique that allows you to package and run applications and their dependencies in isolated environments called containers. One of the most popular containerization platforms is containerd, which is widely used in software development and deployment. Containerization, particularly with open-source technologies like containerd and container orchestration systems like Kubernetes, is a common approach for deploying and managing applications. Containers are created from images, which are lightweight, standalone, and executable packages that include application code, libraries, dependencies, and runtime. Images are often built from a containerfile or similar, which contains instructions for assembling the image. Containerfiles are configuration files that specify how to build a container image. Systems like Kubernetes natively support containerd as a container runtime. They include commands for installing dependencies, copying files, setting environment variables, and defining runtime configurations. Container images can be stored in repositories, which can be public or private. Organizations often set up private registries for security and version control using tools such as Harbor, JFrog Artifactory and Bintray, GitLab Container Registry, or other container registries. Containers can communicate with each other and the external world through networking. Containerd provides a default network namespace, but can be used with custom network plugins. Containers within the same network can communicate using container names or IP addresses.

Remote computing devices 80 are any computing devices not part of computing device 10. Remote computing devices 80 include, but are not limited to, personal computers, server computers, thin clients, thick clients, personal digital assistants (PDAs), mobile telephones, watches, tablet computers, laptop computers, multiprocessor systems, microprocessor based systems, set-top boxes, programmable consumer electronics, video game machines, game consoles, portable or handheld gaming units, network terminals, desktop personal computers (PCs), minicomputers, mainframe computers, network nodes, virtual reality or augmented reality devices and wearables, and distributed or multi-processing computing environments. While remote computing devices 80 are shown for clarity as being separate from cloud-based services 90, cloud-based services 90 are implemented on collections of networked remote computing devices 80.

Cloud-based services 90 are Internet-accessible services implemented on collections of networked remote computing devices 80. Cloud-based services are typically accessed via application programming interfaces (APIs) which are software interfaces which provide access to computing services within the cloud-based service via API calls, which are pre-defined protocols for requesting a computing service and receiving the results of that computing service. While cloud-based services may comprise any type of computer processing or storage, three common categories of cloud-based services 90 are serverless logic apps, microservices 91, cloud computing services 92, and distributed computing services 93.

Microservices 91 are collections of small, loosely coupled, and independently deployable computing services. Each microservice represents a specific computing functionality and runs as a separate process or container. Microservices promote the decomposition of complex applications into smaller, manageable services that can be developed, deployed, and scaled independently. These services communicate with each other through well-defined application programming interfaces (APIs), typically using lightweight protocols like HTTP, protobuffers, gRPC or message queues such as Kafka. Microservices 91 can be combined to perform more complex or distributed processing tasks. In an embodiment, Kubernetes clusters with containerized resources are used for operational packaging of system.

Cloud computing services 92 are delivery of computing resources and services over the Internet 75 from a remote location. Cloud computing services 92 provide additional computer hardware and storage on as-needed or subscription basis. Cloud computing services 92 can provide large amounts of scalable data storage, access to sophisticated software and powerful server-based processing, or entire computing infrastructures and platforms. For example, cloud computing services can provide virtualized computing resources such as virtual machines, storage, and networks, platforms for developing, running, and managing applications without the complexity of infrastructure management, and complete software applications over public or private networks or the Internet on a subscription or alternative licensing basis, or consumption or ad-hoc marketplace basis, or combination thereof.

Distributed computing services 93 provide large-scale processing using multiple interconnected computers or nodes to solve computational problems or perform tasks collectively. In distributed computing, the processing and storage capabilities of multiple machines are leveraged to work together as a unified system. Distributed computing services are designed to address problems that cannot be efficiently solved by a single computer or that require large-scale computational power or support for highly dynamic compute, transport or storage resource variance or uncertainty over time requiring scaling up and down of constituent system resources. These services enable parallel processing, fault tolerance, and scalability by distributing tasks across multiple nodes.

Although described above as a physical device, computing device 10 can be a virtual computing device, in which case the functionality of the physical components herein described, such as processors 20, system memory 30, network interfaces 40, NVLink or other GPU-to-GPU high bandwidth communications links and other like components can be provided by computer-executable instructions. Such computer-executable instructions can execute on a single physical computing device, or can be distributed across multiple physical computing devices, including being distributed across multiple physical computing devices in a dynamic manner such that the specific, physical computing devices hosting such computer-executable instructions can dynamically change over time depending upon need and availability. In the situation where computing device 10 is a virtualized device, the underlying physical computing devices hosting such a virtualized computing device can, themselves, comprise physical components analogous to those described above, and operating in a like manner. Furthermore, virtual computing devices can be utilized in multiple layers with one virtual computing device executing within the construct of another virtual computing device. Thus, computing device 10 may be either a physical computing device or a virtualized computing device within which computer-executable instructions can be executed in a manner consistent with their execution by a physical computing device. Similarly, terms referring to physical components of the computing device, as utilized herein, mean either those physical components or virtualizations thereof performing the same or equivalent functions.

The skilled person will be aware of a range of possible modifications of the various aspects described above. Accordingly, the present invention is defined by the claims and their equivalents.

What is claimed is:

1. A computer system comprising a hardware memory, wherein the computer system is configured to execute software instructions stored on nontransitory machine-readable storage media that:
maintain, in hardware memory, a first latent manifold structured to encode spatiotemporal or perceptually derived states according to a geometric metric governing causal ordering and predictive trajectory computation;
maintain, in hardware memory, a second latent manifold structured to encode cognitive states according to epistemic conditioning information that defines at least one of capacity constraints, admissibility boundaries, or forbidden regions for reasoning trajectories, wherein the first latent manifold and the second latent manifold are geometrically distinct and are maintained as separate representational substrates;
execute a bidirectional geometric interface operator that mediates structured state exchange between the first latent manifold and the second latent manifold, wherein the bidirectional geometric interface operator enforces, at a boundary between the first latent manifold and the second latent manifold:
for inbound transfer from the first latent manifold to the second latent manifold, capacity and admissibility constraints derived from geometric properties of the second latent manifold, and incorporates a transferred state into the second latent manifold as an active cognitive state only when the capacity and admissibility constraints are satisfied; and
for outbound transfer from the second latent manifold to the first latent manifold, epistemic eligibility constraints and physical plausibility constraints derived from geometric properties of the first latent manifold, and incorporates a transferred state into the first latent manifold only when both constraints are satisfied; and
maintain reversible mappings between states transferred across the boundary through cross-manifold journaling with bounded error tolerances.

2. The computer system of claim 1, wherein the first latent manifold is endowed with a pseudo-Riemannian metric of Lorentzian signature that encodes causal ordering relationships among encoded states and supports geodesic trajectory computation and uncertainty representation through causal cone structures, and wherein the second latent manifold is endowed with a semantic metric, an almost-complex structure, a symplectic form reconstructed from the semantic metric and the almost-complex structure under a compatibility relation, and an epistemic connection assigning transition-specific phase values to transitions between cognitive states, such that two regions of the second latent manifold that are identical under the semantic metric may exhibit different epistemic curvature values reflecting different levels of evidential support.

3. The computer system of claim 1, wherein evaluating projected structural density for inbound transfer comprises computing a local capacity measure derived from a symplectic structure of the second latent manifold over a neighborhood of a provisional insertion location and comparing a projected post-insertion density to a stored capacity threshold, and wherein evaluating physical plausibility constraints for outbound transfer comprises computing a deformation energy induced by embedding a cognitive state into the first latent manifold and verifying that the embedded state does not violate compression-pressure constraints of the first latent manifold.

4. The computer system of claim 1, wherein evaluating admissibility constraints for inbound transfer comprises computing a structural compatibility residual by comparing a geometric structure interpolated at the provisional insertion location against geometric structures at neighboring locations in the second latent manifold, performing phase screening over short closed paths through the provisional insertion location to detect local epistemic inconsistency, and determining whether the provisional insertion location conflicts with an admissibility boundary or consolidated reservoir boundary of the second latent manifold, and wherein evaluating epistemic eligibility constraints for outbound transfer comprises verifying that a candidate cognitive state is not marked epistemically inadmissible and does not belong to a suppressed reasoning trajectory class.

5. The computer system of claim 1, wherein the bidirectional geometric interface operator further translates uncertainty representations between the first latent manifold and the second latent manifold, comprising transforming uncertainty structures of the first latent manifold into epistemic confidence measures compatible with the epistemic conditioning of the second latent manifold for inbound transfers, and transforming epistemic uncertainty measures of the second latent manifold into visual uncertainty encodings comprising at least one of opacity gradients, branching trajectory overlays, or probabilistic perturbation envelopes for outbound transfers, wherein the translation preserves monotonic relationships between uncertainty magnitude in the source and target manifolds.

6. The computer system of claim 1, wherein the cross-manifold journaling maintains a cryptographically verified, tamper-evident record of each transfer event by recording source manifold coordinates, target manifold coordinates, transformation parameters, and capacity and admissibility decision codes, and linking successive records through cryptographic hashes, such that any state in the first latent manifold or the second latent manifold that originated through cross-manifold transfer is traceable through stored transformation parameters to its source manifold state within bounded reconstruction error.

7. The computer system of claim 1, wherein the bidirectional geometric interface operator further enforces logical isolation between the first latent manifold and the second latent manifold by preventing states from the first latent manifold from influencing high-commitment cognitive states in the second latent manifold without satisfying admissibility constraints, and by preventing cognitive states from the second latent manifold from reaching actuator outputs or simulation outputs without first being incorporated into the first latent manifold and satisfying physical plausibility constraints of the first latent manifold.

8. The computer system of claim 1, wherein the software instructions further execute an adaptive recalibration process that periodically adjusts capacity thresholds, projection norms, and structural compatibility mappings of the bidirectional geometric interface operator based on current geometric properties of the first latent manifold and the second latent manifold and on historical transfer performance records retrieved from the cross-manifold journaling, such that interface constraints remain calibrated as the first latent manifold and the second latent manifold grow and evolve over time.

9. The computer system of claim 1, wherein the first latent manifold and the second latent manifold are maintained on separate computational nodes, and wherein the bidirectional geometric interface operator is implemented as a network-mediated geometric projection protocol that transfers structured latent state representations and associated metadata between nodes without transferring raw perceptual data or internal reasoning trajectories, and wherein interface capacity mediation is applied prior to transmission to enforce bounded cross-node transfer volume and structural consistency.

10. A computer-implemented method comprising:
maintaining, in hardware memory, a first latent manifold structured to encode spatiotemporal or perceptually derived states according to a geometric metric governing causal ordering and predictive trajectory computation;
maintaining, in hardware memory, a second latent manifold structured to encode cognitive states according to epistemic conditioning information that defines at least one of capacity constraints, admissibility boundaries, or forbidden regions for reasoning trajectories, wherein the first latent manifold and the second latent manifold are geometrically distinct and are maintained as separate representational substrates;
restricting incorporation of states between the first latent manifold and the second latent manifold such that cross-manifold state transfer occurs through execution of a bidirectional geometric interface operator;
executing the bidirectional geometric interface operator to mediate structured state exchange between the first latent manifold and the second latent manifold, the bidirectional geometric interface operator:
for inbound transfer from the first latent manifold to the second latent manifold, performing structural reconciliation between geometric properties of the first latent manifold and geometric properties of the second latent manifold, evaluating projected structural density, deformation, or uncertainty relative to capacity thresholds derived from the second latent manifold, evaluating admissibility constraints derived from the second latent manifold, and incorporating a transferred state into the second latent manifold as an active cognitive state only when the capacity and admissibility constraints are satisfied; and
for outbound transfer from the second latent manifold to the first latent manifold, performing structural reconciliation between geometric properties of the second latent manifold and geometric properties of the first latent manifold, evaluating epistemic eligibility constraints and physical plausibility constraints derived from the first latent manifold, and incorporating a transferred state into the first latent manifold only when both constraints are satisfied; and
maintaining reversible mappings between states transferred across a boundary enforced by the bidirectional geometric interface operator through cross-manifold journaling with bounded error tolerances.

11. The method of claim 10, wherein the first latent manifold is endowed with a pseudo-Riemannian metric of Lorentzian signature that encodes causal ordering relationships among encoded states and supports geodesic trajectory computation and uncertainty representation through causal cone structures, and wherein the second latent manifold is endowed with a semantic metric, an almost-complex structure, a symplectic form reconstructed from the semantic metric and the almost-complex structure under a compatibility relation, and an epistemic connection assigning transition-specific phase values to transitions between cognitive states, such that two regions of the second latent manifold that are identical under the semantic metric may exhibit different epistemic curvature values reflecting different levels of evidential support.

12. The method of claim 10, wherein evaluating projected structural density for inbound transfer comprises computing a local capacity measure derived from a symplectic structure of the second latent manifold over a neighborhood of a provisional insertion location and comparing a projected post-insertion density to a stored capacity threshold, and wherein evaluating physical plausibility constraints for outbound transfer comprises computing a deformation energy induced by embedding a cognitive state into the first latent manifold and verifying that the embedded state does not violate compression-pressure constraints of the first latent manifold.

13. The method of claim 10, wherein evaluating admissibility constraints for inbound transfer comprises computing a structural compatibility residual by comparing a geometric structure interpolated at the provisional insertion location against geometric structures at neighboring locations in the second latent manifold, performing phase screening over short closed paths through the provisional insertion location to detect local epistemic inconsistency, and determining whether the provisional insertion location conflicts with an admissibility boundary or consolidated reservoir boundary of the second latent manifold, and wherein evaluating epistemic eligibility constraints for outbound transfer comprises verifying that a candidate cognitive state is not marked epistemically inadmissible and does not belong to a suppressed reasoning trajectory class.

14. The method of claim 10, wherein executing the bidirectional geometric interface operator further comprises translating uncertainty representations between the first latent manifold and the second latent manifold, comprising transforming uncertainty structures of the first latent manifold into epistemic confidence measures compatible with the epistemic conditioning of the second latent manifold for inbound transfers, and transforming epistemic uncertainty measures of the second latent manifold into visual uncertainty encodings comprising at least one of opacity gradients, branching trajectory overlays, or probabilistic perturbation envelopes for outbound transfers, wherein the translation preserves monotonic relationships between uncertainty magnitude in the source and target manifolds.

15. The method of claim 10, wherein maintaining reversible mappings comprises maintaining a cryptographically verified, tamper-evident record of each transfer event by recording source manifold coordinates, target manifold coordinates, transformation parameters, and capacity and admissibility decision codes, and linking successive records through cryptographic hashes, such that any state in the first latent manifold or the second latent manifold that originated through cross-manifold transfer is traceable through stored transformation parameters to its source manifold state within bounded reconstruction error.

16. The method of claim 10, wherein executing the bidirectional geometric interface operator further comprises enforcing logical isolation between the first latent manifold and the second latent manifold by preventing states from the first latent manifold from influencing high-commitment cognitive states in the second latent manifold without satisfying admissibility constraints, and by preventing cognitive states from the second latent manifold from reaching actuator outputs or simulation outputs without first being incorporated into the first latent manifold and satisfying physical plausibility constraints of the first latent manifold.

17. The method of claim 10, further comprising executing an adaptive recalibration process that periodically adjusts capacity thresholds, projection norms, and structural compatibility mappings of the bidirectional geometric interface operator based on current geometric properties of the first latent manifold and the second latent manifold and on historical transfer performance records retrieved from the cross-manifold journaling, such that interface constraints remain calibrated as the first latent manifold and the second latent manifold grow and evolve over time.

18. The method of claim 10, wherein the first latent manifold and the second latent manifold are maintained on separate computational nodes, and wherein the bidirectional geometric interface operator is implemented as a network-mediated geometric projection protocol that transfers structured latent state representations and associated metadata between nodes without transferring raw perceptual data or internal reasoning trajectories, and wherein interface capacity mediation is applied prior to transmission to enforce bounded cross-node transfer volume and structural consistency.
